(19) United States
(12) Patent Application Publication
(10) Pub. No.: US 2021/0044640 A1
(43) Pub. Date: Feb. 11, 2021

(54) LIVESTREAMING INTERACTIVE CONTENT TO A DIGITAL MEDIA PLATFORM

(71) Applicant: GURU NETWORK LIMITED, Hong Kong (HK)

(72) Inventor: Xiaocong HE, Palo Alto, CA (US)

(21) Appl. No.: 16/537,494

(22) Filed: Aug. 9, 2019

(51) Int. Cl. H04L 29/06; G06F 3/16; G10L 15/26; H04L 12/18

(52) U.S. Cl. CPC H04L 65/4076; H04L 12/1813; G10L 15/265; G06F 3/165

(57) ABSTRACT

Disclosed embodiments include systems and methods for generating and distributing audio content including live interactions. In various embodiments, performers create audio content in a live room accessible by members of a digital media platform. Members may connect to the live room through the digital media platform to become part of the audio content creation process. The live room may be configured to enable a variety of live interactions including text messaging, call-ins, and virtual gifting in order to promote stronger engagement with content created on the digital media platform. Live audio content created by performers and/or members engaging in live interactions may be recorded and distributed on the digital media platform using an in-audio search functionality that exposes dialogue included in the audio content for text based search.

### FIELD

The present disclosure relates generally to content creation and distribution and, more specifically, to generating interactive audio content distributed on a digital media platform.

### BACKGROUND

The proliferation of the internet and connected devices have caused digital content to displace printed media as a primary source of entertainment. Music and dialogue based audio content are important subsets of digital media that are easier to distribute and consume relative audiovisual works. Audio files require less bandwidth the download and/or stream and can be played when performing activities that require minimal visual distractions (e.g., driving, cleaning, exercising, cooking, supervising children, and the like). Audio content also engages a distinct part of the human brain and forces people to actively engage with sounds and dialogue rather than passively consuming visual appearances. Accordingly, interest in creating new forms of audio content and systems for distributing audio files has exploded in recent years.

Podcasts are static audio programs that are typically dialogue centered. The production costs for creating a podcast episode is typically quite minimal so almost anyone can perform a podcast and distribute it publically over the internet. Despite the accessibility of podcast content creation and platforms for widely distributing podcast episodes, listeners have no way to interact with podcast performers during the podcast performance.

Previous attempts have been made to make audio content interactive including radio talk shows. Although these programs allow listeners to talk with show hosts on the air, the types of listener interactions are limited, listeners can be put on hold for long periods of time making calling-in inconvenient, and there is little chance to interact with other listeners.

The number of unique podcast programs available has exploded due to increasing interest in digital audio content. With hundreds of thousands of podcast titles to choose from, it is very difficult to find specific podcast episodes of interest. Additionally, low barriers to entry and minimal review or curation of podcast content uploaded to podcast platforms, makes identifying quality podcasts difficult. It is also difficult for people to quickly determine if they like a particular podcast show or performer without listening to a good chuck of a podcast episode.

Previous attempts have been made to create mechanism for searching audio files including keyword based search algorithms. These methods rely on descriptive text (e.g., titles, file names, episode descriptions, and the like) which can be misleading and non-comprehensive. Drafting descriptive text for each episode can also be time consuming, thereby undermining the accessibility of podcast content creation. Moreover, even after finding an episode to listen to, finding the portion of the episode relevant to the search is time consuming and requires listening to the episode from the beginning or randomly playing portions of the episode.

### SUMMARY

In one aspect, disclosed herein are methods of livestreaming interactive content to a digital media platform that may comprise: generating, by a livecast agent, a live room for broadcasting a livecast, the livecast comprising one or more content streams created inside the live room, the live room identified by a performer hosting the livecast and livecast metadata including live room access information, the live room including one or more parameters for configuring the livecast; publishing the live room and live room access information on the digital media platform; using the live room access information, connecting one or more digital media platform users to the live room by establishing a network connection between an instance of a digital media platform on a user device of the one or more digital media platform users and a server device hosting the live room; streaming the one or more content feeds included in the livecast to the one or more digital media platform users connected to the live room and the performer; receiving, inside the live room, one or more live user interactions with at least one content stream included in the livecast; recording an audio content stream included in the livecast as a podcast episode; uploading the podcast episode to the digital media platform; and distributing the podcast episode on the digital media platform, wherein dialogue included in the podcast episode is text searchable on the digital media platform.

In one aspect, the livecast metadata may include livecast title, one or more greetings to livecast listeners, searchable tags, the number of digital media platform users connected to the livecast, and a cover photo. In one aspect, the one or more live user interactions may comprise a text message, a phone call, a virtual gift, a content rating, and a podcast channel subscription. In one aspect, the one or more content streams may include an audio content stream from the performer and an audio content stream from at least one of the one or more digital media platform users connected to the live room. In one aspect, the one or more content streams may include a content feed displaying text comments, user call-in history, virtual gift transactions, and the one or more digital media platform users connected to the live room.

In one aspect, the method of livestreaming interactive content may comprise generating a notification including livecast metadata and live room access information including a link to access the livecast on the digital media platform; and distributing the notification to a social media platform. In one aspect, the link to access the livecast may include a playback position that directs one or more users of a social media platform accessing the livecast using the link to the playback position within a playback timeline of the livecast to allow the one or more users of a social media platform to begin playing the livecast from the playback position instead of the beginning of the livecast. In one aspect, live room may be generated automatically according to a schedule specifying one or more dates and times for streaming the livecast. In one aspect, the method of livestreaming interactive content may comprise, in advance of the generating the live room, creating a notification including an upcoming date and time for streaming the livecast, the livecast metadata, and access information including a link to access the livecast on the digital media platform; and distributing the notification to a social media platform. In one aspect, the link may be a static link that remains constant for all livecasts hosted by the performer. In one aspect, the one or more parameters may comprise privacy settings, explicit content identification, notification settings, and recording settings. In one aspect, the performer may restrict digital media platform users that can connect to the livecast using the privacy settings.

In one aspect, disclosed herein are methods of livestreaming audio content to a digital media platform that may comprise: generating, by a livecast agent, a live room for broadcasting a livecast, the livecast comprising one or more content streams created inside the live room, the live room identified by a performer hosting the livecast and livecast metadata including live room access information, the live room including one or more parameters for configuring the livecast; publishing the live room and live room access information on the digital media platform; using the live room access information, connecting one or more digital media platform users to the live room by establishing a network connection between an instance of a digital media platform on a user device of the one or more digital media platform users and a server device hosting the live room; streaming the one or more content feeds included in the livecast to the one or more digital media platform users connected to the live room and the performer; receiving, inside the live room, one or more live user interactions with at least one content stream included in the livecast; recording an audio content stream included in the livecast as a podcast episode; receiving, by an audio analyzer, the podcast episode, the audio analyzer generating a text to audio index for the podcast by: slicing the podcast episode into audio clips including segments of dialogue; for each audio clip, obtaining text and timeline information for every word included in the dialogue, the timeline information placing each word in a position on a playback timeline that corresponds with the playback time of the podcast episode when the word was spoken; and calibrating the timeline information to correct in-accurate timeline positions of one or more words included in the dialogue; and distributing the podcast episode to the digital media platform, wherein dialogue included in the podcast episode is text searchable on the digital media platform using the text to audio index.

In one aspect, the live room may be generated automatically according to a schedule specifying one or more dates and times for streaming the livecast. In one aspect, the calibrating timeline information comprises applying a scaling factor to expand the playback timeline to allow more words to be placed in a unique timeline position on the timeline. In one aspect, the calibrating timeline information may comprise applying a scaling factor to compress the playback timeline to reduce the number of unique timeline positions available for placing words on the timeline.

In one aspect, disclosed herein are methods of livestreaming interactive content to a digital media platform that may comprise: generating, by a livecast agent, a live room for broadcasting a livecast, the livecast comprising one or more content streams created inside the live room, the live room identified by a performer hosting the livecast and livecast metadata including live room access information, the live room including one or more parameters for configuring the livecast; publishing the live room and live room access information on the digital media platform; using the live room access information, connecting one or more digital media platform users to the live room by establishing a network connection between an instance of a digital media platform on a user device of the one or more digital media platform users and a server device hosting the live room; streaming the one or more content feeds included in the livecast to the one or more digital media platform users connected to the live room and the performer; receiving, inside the live room, a call-in live user interaction including an audio interaction between a digital media platform user connected to the live room and the performer; recording one or more audio content streams included in the livecast as a podcast episode, the recorded one or more audio content streams comprising the audio interaction included in the call-in live user interaction; uploading the podcast episode to the digital media platform; and distributing the podcast episode on the digital media platform, wherein dialogue included in the call-in live user interaction is text searchable on the digital media platform.

In one aspect, the one or more content streams may include an audio content stream from the performer, an audio content stream from at least one of the one or more digital media platform users connected to the live room, and a content feed displaying text comments, user call-in history, virtual gift transactions, and profile names of the one or more digital media platform users connected to the live room. In one aspect, the method of livestreaming interactive content to a digital media platform may comprise receiving a text message live interaction from the digital media platform user, the text message live interaction including a text message published in the content feed. In one aspect, the method of livestreaming interactive content to a digital media platform may comprise receiving a virtual gift live interaction from the digital media platform user, the virtual gift including an image of the virtual gift given by the digital media platform user to the performer, the virtual gift published in the content feed and redeemable, on the digital media platform, for a cash value by the performer.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 depicts an exemplary system for livestreaming audio content to a digital media platform, according to embodiments of the disclosure.

FIG. 2 illustrates more details of the system shown in FIG. 1, according to embodiments of the disclosure.

FIG. 3 is a flow diagram illustrating an exemplary process for livestreaming audio content to a digital media platform, according to embodiments of the disclosure.

FIG. 4 is a flow diagram showing an exemplary logic indexing recorded audio content, according to embodiments of the disclosure.

FIGS. 5A-K illustrate exemplary live room setup GUIs for configuring live rooms and livecast sharing GUIs for sharing livecast content, according to embodiments of the disclosure.

FIGS. 6A-J illustrate exemplary live interaction GUIs for engaging in one or more live interactions with livecasts, according to embodiments of the disclosure.

FIGS. 7A-C illustrate exemplary file management GUIs for uploading recorded livecast audio files for distribution, according to embodiments of the disclosure.

FIGS. 8A-B illustrate exemplary search results provided by the digital media platform, according to embodiments of the disclosure.

FIG. 9 is a block diagram of an illustrative server device that may be used to implement the system of FIG. 2, according to embodiments of the disclosure.

FIG. 10 is a block diagram of an illustrative user device that may be used to implement the system of FIG. 2, according to embodiments of the disclosure.

FIG. 11 illustrates an exemplary content moderation system, according to embodiments of the disclosure.

### DESCRIPTION

As used herein, the terms “livecast” and “livecasts” refer to a live streamed show created and/or broadcast in a live room that includes one or more content streams. In various embodiments, the content streams may include interactive content including an interactive component allowing one or more members of the listening audience to interact with performers hosting a livecast, members of the listening audience, and/or one or more content streams in real time. Livecast episodes may be generated by a performer who hosts and manages the livecast. To start a livecast, the performer generates a live room that digital media platform users can join to livestream the livecast and participate in live user interactions. The content streams included in a livecast may be one or more audio streams, content feeds including audio text, and/or image data, audio visual streams, and the like. By providing content creation and livestreaming functionality that supports live user interactions, the digital media platform described herein makes content more engaging and entertaining.

The digital media platform facilitates more efficient content creation by integrating different functionalities provided by distinct hardware systems into a live room. The live room integrates functionality provided by a streaming client, digital chat room, instant messenger, conference call telephone, payment platform, audio recording device, scheduling assistant, search engine, and the like into one central location to increase the efficiency and speed of content creation. The live room eliminates hardware, computing capacity, memory resources, and network communications required to provide equivalent functionality of the live room using alternative methods. By integrating functionality provided by discreet platforms into one location, the live room improves the content consumption user experience by making it easier for performers and the audience to create, communicate with—and engage in—livecast content in the way they want (e.g., talk, text, pay, listen, share, and the like) in real time. The live room also improves the content creation user experience by giving performers more mediums of expression (e.g., audio stream, content feed, interview, audience conversation, playlist, and the like) without requiring additional hardware, software services, computing power, memory capacity, or network communications to support each new medium of expression.

The digital media platform integrates the functionality providing by the live room into a content distribution platform having an in-audio search engine. The digital media platform enhances livecast content by archiving it for future listening and making livecast content accessible by a large network of users quickly and efficiently without requiring the computing, memory, and networking resources required to answer queries attempting to locate a particular livecast episode using only livecast metadata and/or stream a livecast episode to search within the livecast for a relevant portion of livecast dialogue. The digital media platform also merges content creation and streaming functionality with content discovery, publishing, and/or distribution functionality to avoid computing, memory, and networking resources required to download and/or use an application for content creation and streaming that is separate from a second application for content discovery, publishing, and/or distribution.

As used herein, the term “content” refers to audio content, audio visual content, images, written text, and any other form of content. In various embodiments, content may include audio content in the form of sound entertainment having an interactive component including music, podcasts, audiobooks, and the like. One or more visual displays accompanying the audio content, for example, content feeds including text and image information, images, video, written text, and the like may also be included in content as described in the disclosure. Content included in a livecast may be livestreamed in a live room to users and performers connected to the live room.

As used herein, the terms “performer” and “performers” refers to a person or group of people that generates a live room, hosts a livecast in a live room, joins a livecast, and/or generates content included in a livecast.

As used herein, the terms “members of the community” “member of the community”, “community members”, and “community member” refer to digital media platform users and/or accounts that may join a live room to livestream a livecast. Live rooms may be joined from an instance of a digital media platform that provides livecasts, a social media platform, and/or other mobile or web based application connected to the internet and executed on a user device.

As used herein the terms “live room” and live rooms” refer to a digital space within a digital media platform for creating and livestreaming livecasts and other audio content to a live audience. To receive the livecast livestream, a member of the live audience may be required to connect to a live room hosted on a digital media platform.

As used herein the term “dialogue” refers to monologues, dialogue, conversations, lyrics, and any other spoken content included in a piece of content.

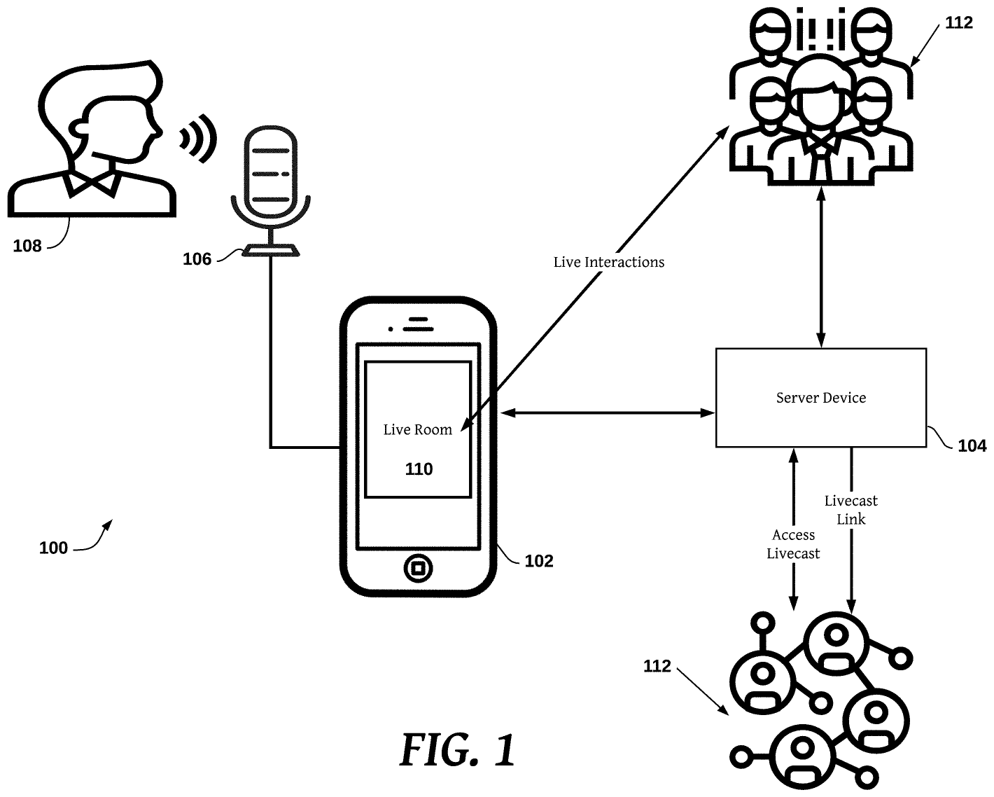

FIG. 1 illustrates an example embodiment of a livecasting system 100 that may generate and distribute livecasts including one or more content streams. The livecasting system 100 may include a user device 102 having a microphone 106 that records sounds produced by one or more performers 108 as one or more audio content streams included in a livecast. The user device 102 may include a livecast agent that generates a live room 110 for hosting a livecast. The live room may be generated within an instance of a digital media platform executed on the user device 102. In various embodiments, content streams captured within a live room 110 is live broadcast to a community 112. In various embodiments, the content streams may be livestreamed of a plurality of user devices executing instances of the digital media platform.

To livestream livecasts, content streams included in the livecast may be transferred to a server device 104 in real time for distribution to the community 112. The server device 104 may include a streaming engine for streaming the content streams generated by the one or more performers 108 to the community 112. Within the live room 110, one or more members of the community 112 may interact with one or more performers 108 or content streams using a variety of live interactions enabled by the live room 110. In various embodiments, members of the community 112 may send a text message to the live room to comment on a content stream, ask one or more performers a question, have a discussion with other members of the community 112, and the like. Members of the community 112 may also call into the live room 110 where a performer 108 can decide to interact with the one or more members of the community 112 on a live phone call within the live room 110. Members of the community 112 may also send gifts, money, and other rewards to the one or more performers using transactions enabled by the live room 110.

Performers 108 may configure live rooms 110 to send notifications to fans when important events happen (e.g., a livecast starts, a particular community member calls in, a topic is brought up in the live room chat, and the like). Live rooms may be configured to notify members of the community 112 if a livecast contains explicit content. To promote privacy, performers 108 may configure live rooms 110 to have public or private access. In various embodiments, only a subset of members of the community 112 or particular guests invited by a performer 108 are allowed to enter live rooms 110 having private access. Live rooms 110 may also be configured to limit the type of interactions and/or the members of the community who may interact within a live room 110. Live rooms 110 may also be configured to auto record audio content as an audio file that may be provided to a server device 104 for storage and distribution to a social network 114 and/or members of the community 112 using an in-audio search feature for quickly locating interesting audio content. Once a live room 110 is generated, one or more performers 108 may share links to live rooms 110 to a social network (e.g., Facebook, Twitter, Instagram, Snapchat, Wechat, Line, and the like) 114. One or more members of a social network 114 may use the link to directly access the live room 110 thereby joining the community of members 112 that may engage in live interactions with one or more performers 108 or the content streams.

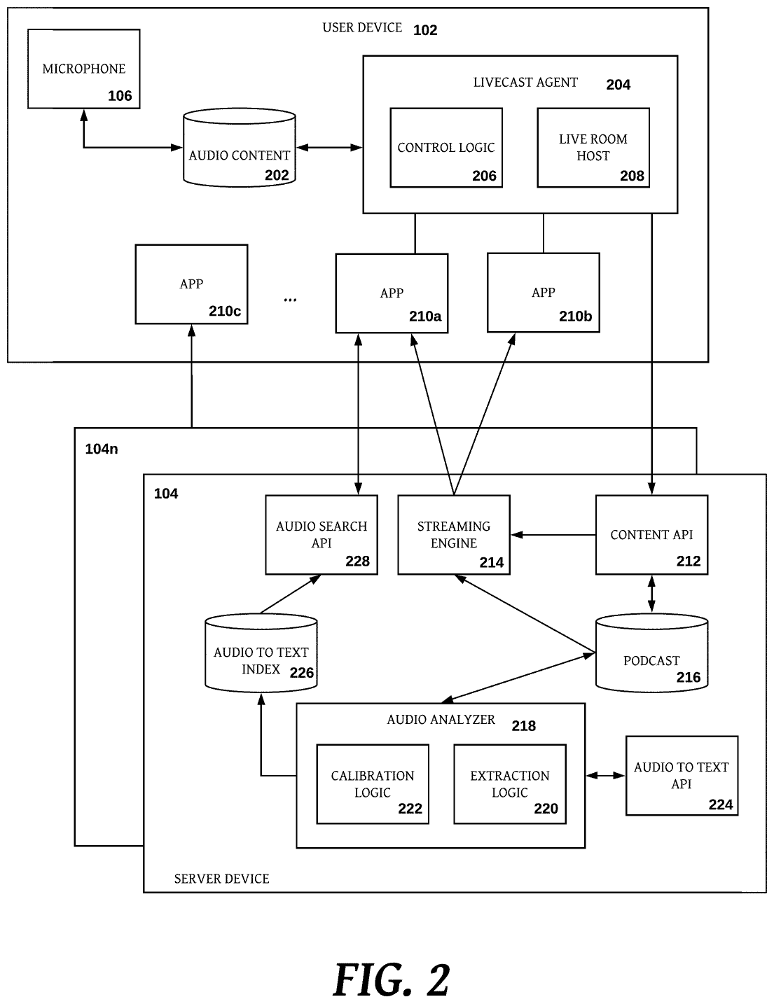

FIG. 2 illustrates more details of the user device 102 and server device 104 shown in FIG. 1. The components shown in FIG. 2 provide the functionality delivered by the user device 102 and server device 104 shown in FIG. 1. As used herein, the term “component” may be understood to refer to computer executable software, firmware, hardware, and/or various combinations thereof. It is noted that where a component is a software and/or firmware component, the component is configured to affect the hardware elements of an associated system. It is further noted that the components shown and described herein are intended as examples. The components may be combined, integrated, separated, or duplicated to support various applications. Also, a function described herein as being performed at a particular component may be performed at one or more other components and by one or more other devices instead of or in addition to the function performed at the particular component. Further, the components may be implemented across multiple devices or other components local or remote to one another. Additionally, the components may be moved from one device and added to another device, or may be included in both devices.

As shown in FIG. 2, the user device 102 may include a microphone 106 that records audio content for a livecast show. Audio content captured by the microphone 106 may be stored in an audio content database 202. To efficiently store audio content, the audio content database may be implemented as a local data store included in a user device 102 and/or one or more remote cloud storage instances that receive audio content from a user device using file/data lossless transfer protocols such as HTTP, HTTPS or FTP. The audio content database 202 may store audio content in various ways including, for example, as an audio file, audio file formatted for streaming (e.g., an audio file having an audio coding format including MP3, Vorbis, AAC, Opus. and the like) a flat file, indexed file, hierarchical database, relational database, unstructured database, graph database, object database, and/or any other storage mechanism. The audio content database 202 may also store audiovisual files including video and/or image data combined with audio content. A livecast agent 204 may receive and/or store audio content in the audio content database 202. In various embodiments, the livecast agent 204 transfers audio content to and from the audio content database 202 using file/data lossless transfer protocols such as HTTP, HTTPS or FTP.

The livecast agent 204 may generate and/or configure live rooms for hosting livecast shows. In various embodiments, a server device 104 may facilitate livestreaming livecasts to a plurality of applications 210a-c. One or more members of a community on an digital media platform application 210a (e.g., application account holders, social network members, users, humans and devices accessing the application, and the like) may join a live room to livestream a livecast and/or engage in one or more live interactions with livecast performers, other community members, and/or content streams included in the livecast. To livestream livecasts to a plurality of user devices 102 executing instances of an digital media platform application 210a, the livecast agent 204 may send content streams (e.g., audio content streams, live interaction content streams, indication information, content feed, and other data included in the live room) and access information for the live room to a content API 212. Access information for the live room transferred to the content API 212 may include signaling information (e.g., data, messages, and metadata about the live room content) and connection information (e.g., a public IP address and/or other data for establishing a connection over WebRTC or another known real time communications protocol). In various embodiments, the content API 212 may transfer the content streams and access information for live rooms to a streaming engine 214 for distribution to one or more instances of a digital media platform application 210a and/or other application 210b executed by a user device. The content API 212 can also include functionality for distributing content streams and/or communication information for live rooms directly to one or more applications 210a, 210b. In various embodiments, the content API 212 and/or the streaming engine 214 may distribute content streams and or access information to one or more applications 210a, 210b as a link to an address for accessing the live room. Community members may find the link within the digital media platform application 210a and access the live room by selecting the link. A communications client within the digital media platform application 210a may join the live room located at the linked address using the access information. Once connected to the live room, the communications client may stream one or more content streams included in the live room over WebRTC on another known real time communications protocol.

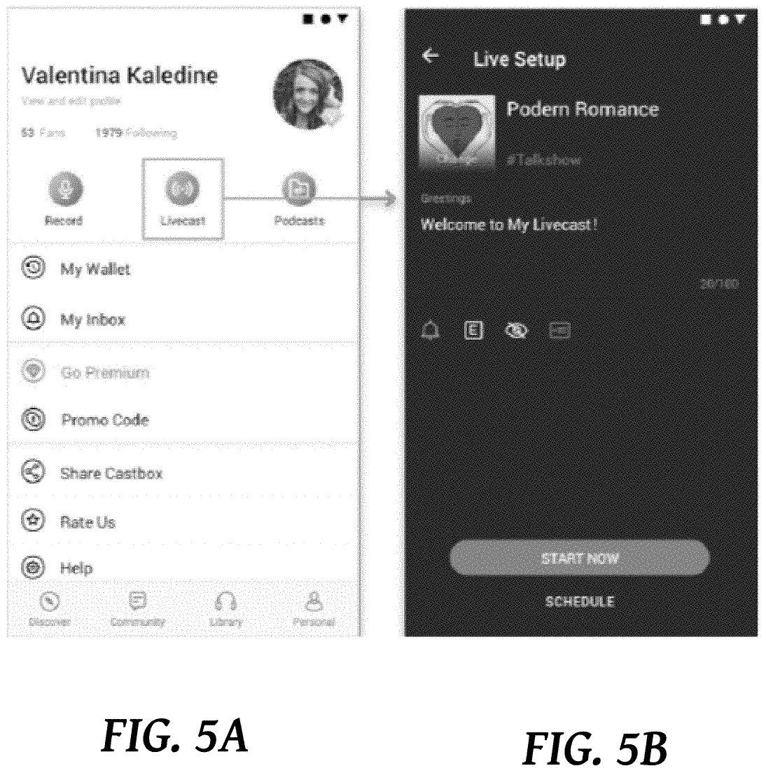

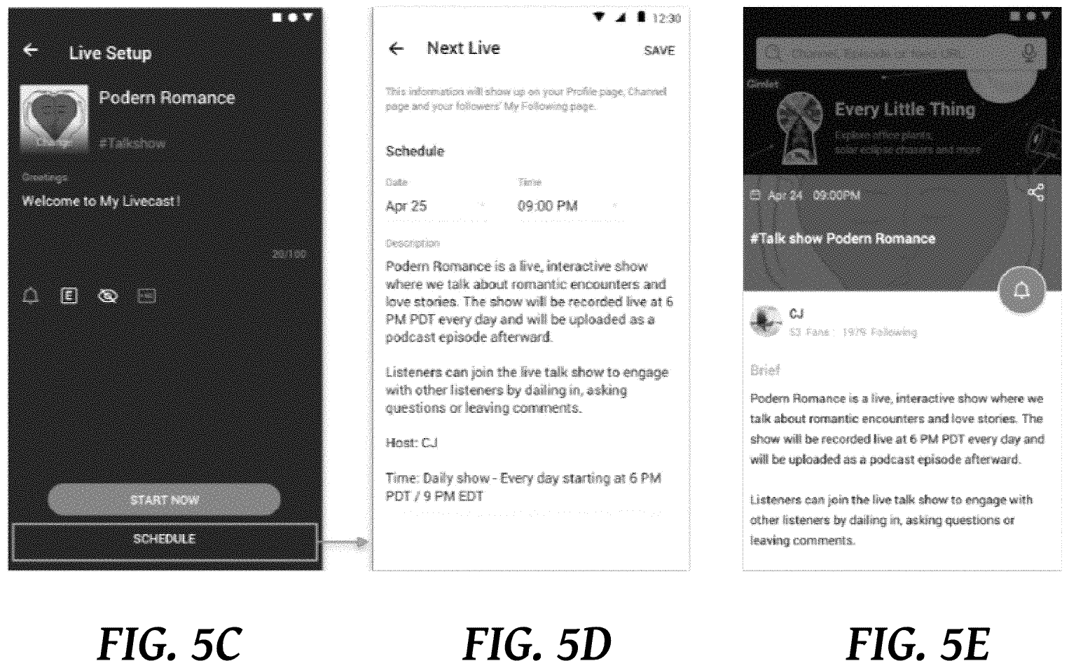

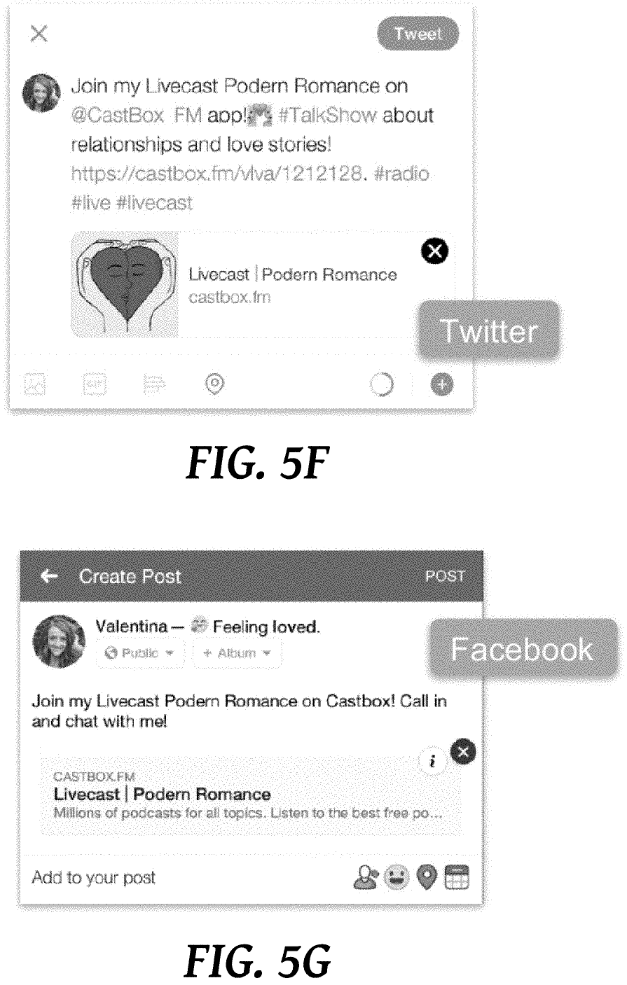

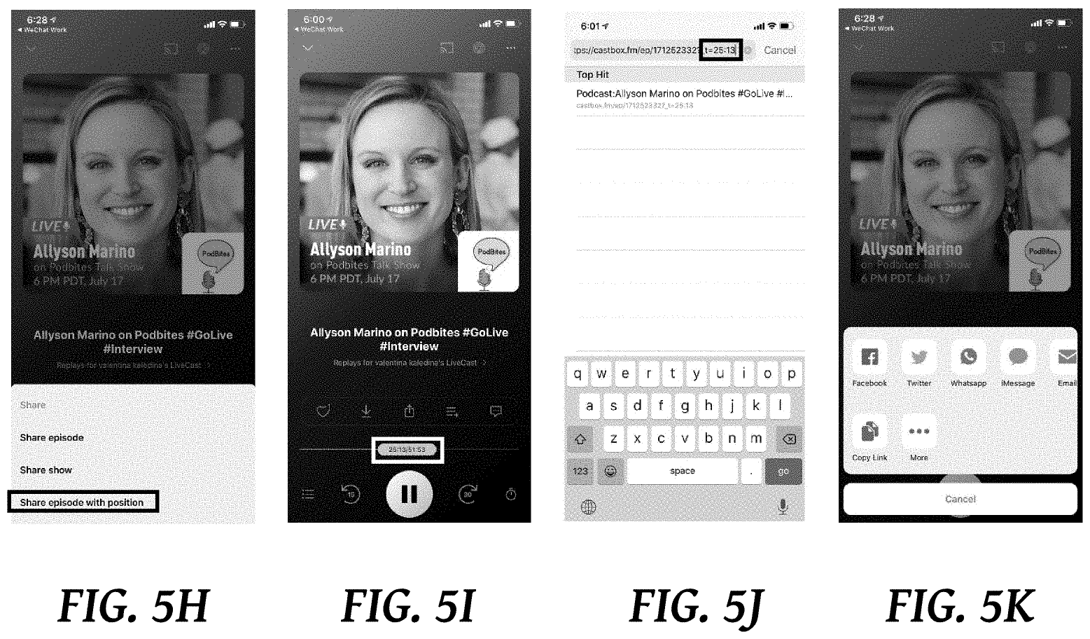

The livecast agent 204 may be implemented as a feature, plug-in, and/or extension of a mobile or web based application 210a-c and/or a stand-alone application. In various embodiments, the livecast agent 204 includes a live room host 208 that may generate and maintain a live room during the performance of a livecast. The live room host 208 may persist and maintain data required by the live room (e.g., livecast identification information, live room access information, live feed content, ids for community members that joined the livecast, live room content streams and the like). The live room host 208 can include a communications component that provides access information and other data needed for community members to establish a connection with a live room. Features of live rooms may be configured according to instructions provided by control logic 206. For example, live room privacy and access, live interactions supported by the live room, live room identification information, and/or livecast distribution/notifications may be set by control logic 206. Performers may also schedule creation of live rooms for hosting livecasts using functionality provided by control logic 206. To begin a livecast, the live room host 208 generates a live room according to features specified by control logic 206. The livecast agent 204 may provide one or more livecast configuration GUIs displayed on a user device 102 to facilitate configuring control logic 206 according to the preferences of one or more livecast performers. The one or more livecast configuration GUIs may be displayed within an instance of a digital media platform application 210a executed by the user device 102. Exemplary livecast setup GUIs are provided below in FIGS. 5A-G. Once a live room has been created, one or more members of the community may join a live room to access the livecast. The community members that are able to access a livecast may be determined by control logic 206. For example, a live room including a particular livecast may be configured as private by control logic 206. Only a subset of community members, for example, community members invited by one or more livecast performers may join a private live room. In various embodiments, live rooms may be configured as public by control logic 206. Public live rooms may be accessed by all community members. Control logic 206 may also be configured to schedule generation of live rooms on a future date and time specified by one or more performers. In various embodiments, control logic 206 may be configured to schedule generation of live rooms at regular intervals (e.g., every 2 days, every 3 days, every 12 hours, and the like) and/or at a fixed time (e.g., every fifth day of the month, every other Tuesday, once a month, once a week, and the like). Exemplary livecast setup GUIs are provided below in FIGS. 5C-E and one or more livecast setup GUIs may be displayed within an instance of a digital media platform application 210a executed by the user device 102.

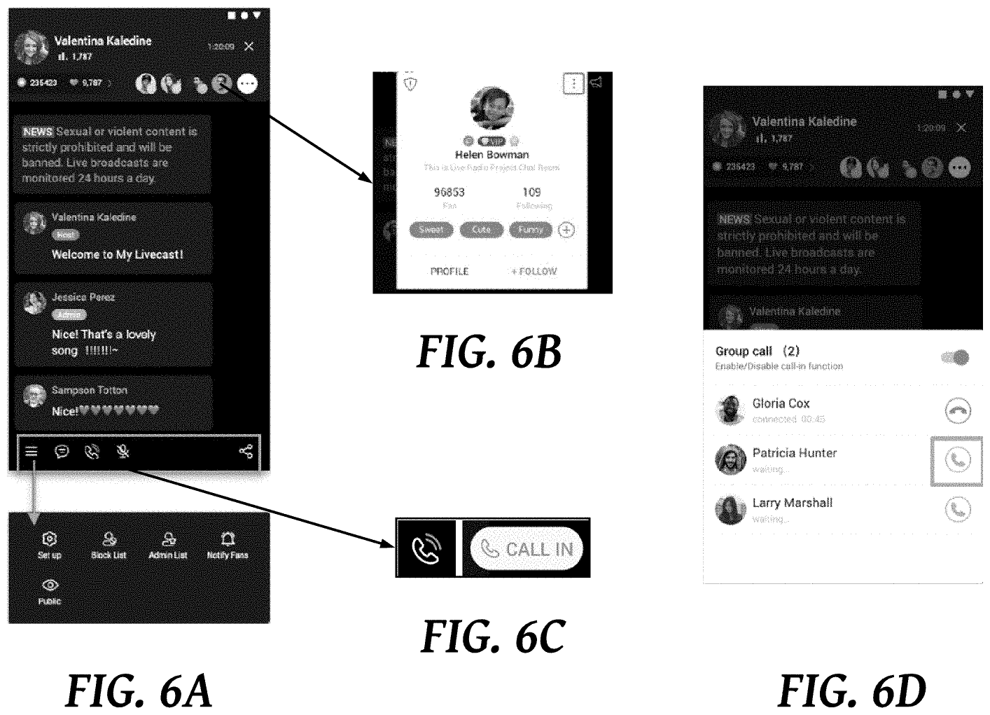

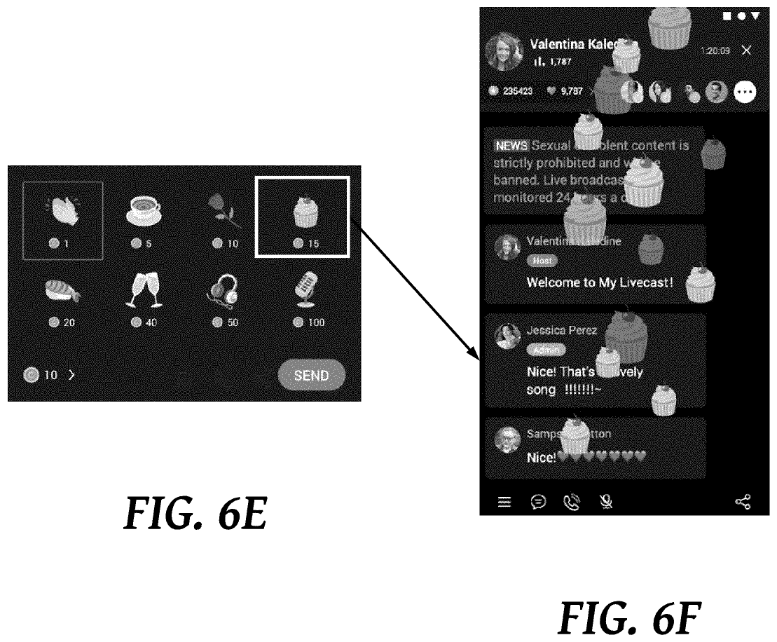

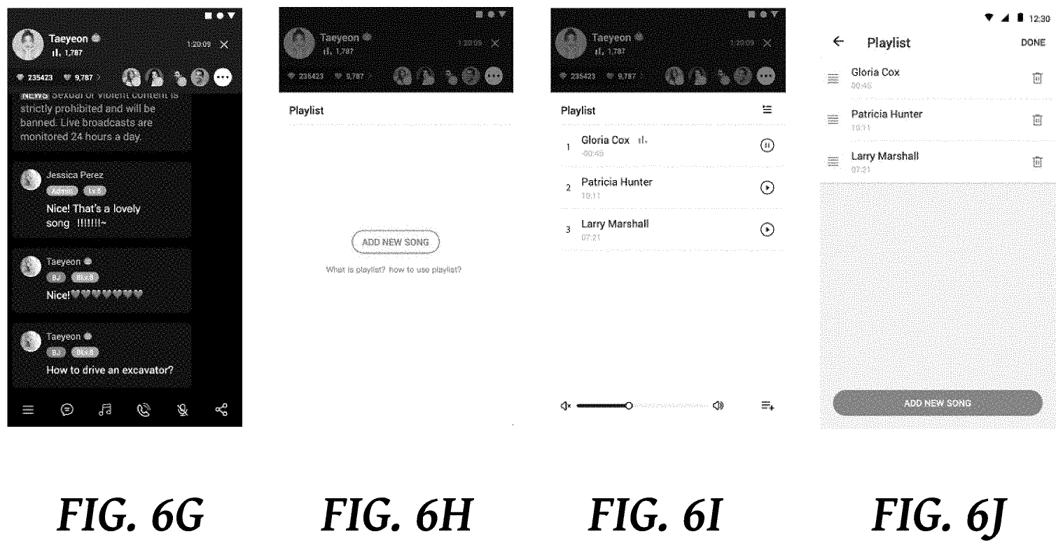

Once community members join a live room, they may engage in one or more live interactions with one or more performers of the livecast, community members connected to the live room, and/or livecast content. Control logic 206 may define the type of live interactions community members may perform within the live room. For example, a performer may determine she does not want to include call-ins or other live interactions including live audio from one or more community members. Accordingly, control logic 206 may configure the live room to support text comments and virtual gifts, but not call-in live interactions. The community members able to perform a specific type of live interaction may also be determined by control logic 206. For example, control logic 206 may setup a live room to accept virtual gifts from only certain community members invited by a livecast performer. FIGS. 6A-J below describe exemplary live interactions that may be enabled by control logic 206. In various embodiments, control logic 206 may configure live rooms to allow livecast performers to control live interactions that occur within a live room. For example, to help moderate behavior of community members within a live room and maintain control over a livecast show, one or more performers may use control logic 206 to accept or decline a call-in from a particular community member. Performers may also use control logic 206 to block one or more community members from joining a live room. In various embodiments, control logic 206 may be configured to generate and distribute notifications to increase visibility of livecast shows and/or help remind loyal listeners of upcoming livecasts. Notifications may include identification information (e.g., title, description, greeting, data and time, and the like) for a livecast and a link including the location address for the live room. Control logic 206 may distribute notifications to one or more applications 210a-c, for example, social media platforms (e.g., Facebook, Twitter, Instagram, Snapchat, Wechat, Line, and the like). Exemplary notifications and notification setup GUIs generated by control logic 206 are shown below in FIGS. 5E-K. The one or more notifications and notification setup GUIs may be displayed within an instance of a digital media platform application 210a executed by the user device 102.

In various embodiments, control logic 206 may record one or more audio content streams included in a livecast as an audio file. Recorded livecasts may be uploaded to a performer's or podcast's channel where it may be livestreamed by community members. To facilitate streaming, the livecast agent 204 uploads livecasts recorded by control logic 206 to a content API 212 included in a server device 104 using file/data lossless transfer protocols such as HTTP, HTTPS or FTP. The content API 212 may store recorded livecast shows in a podcast data store 216. In various embodiments, the podcast data store 216 may be implemented as a local data store included in a server device 104 and/or one or more remote cloud storage instances. The podcast data store 216 may store audio content in various ways including, for example, as an audio file, audio file formatted for streaming (e.g., an audio file having an audio coding format including MP3, Vorbis, AAC, Opus. and the like) a flat file, indexed file, hierarchical database, relational database, unstructured database, graph database, object database, and/or any other storage mechanism.

To distribute audio content to one or more application 210a-c instances, a streaming engine 214 may read audio files from a podcast data store 216. The content API 212 may also provide content streams and/or audio files to a streaming engine 214 directly from a livecast agent 204 and/or from a podcast data store 216. In various embodiments, the content streaming engine 214 and/or the content API 212 may include a media codec (e.g., audio and/or video codec) having functionality for encoding content streams including video and audio content received from a livecast agent 102 into a format for streaming (e.g., an audio coding format including MP3, Vorbis, AAC, Opus, and the like and/or a video coding format including H.264, HEVC, VP8 or VP9) using a known streaming protocol (e.g., real time streaming protocol (RTSP), real-time transport protocol (RTP), real-time transport control protocol (RTCP), and the like). The content streaming engine 214 and/or the content API 212 may then assemble encoded audio and/or video streams in a container bitstream (e.g., WAV, MP4, FLV, WebM, ASF, ISMA, and the like) that is provided by the streaming engine 214 to a plurality of streaming clients included in one or more mobile and/or web based applications 210a, 210b. In various embodiments, the streaming engine 214 may provide the bitstream to a plurality of application 210a, 210b streaming clients using a known transport protocol (e.g., RTP. RTMP. HLS by Apple. Smooth Streaming by Microsoft. MPEG-DASH by Adobe, and the like) that supports adaptive bitrate streaming over HTTP or other known web data transfer protocol.

In various embodiments, a digital media platform application 210a may provide an search functionality that allows users to search dialogue, lyrics, and other spoken portions of recorded livecast shows and other audio content. An audio analyzer 218 included in a server device 104 may provide in-audio search functionality by extracting text and timeline information from audio files included in the podcast data store 216 and generating an audio to text index that can be used by an audio search API to provide results for queries submitted by community members looking for audio files having dialogue and other audio content including particular keywords. In various embodiments, the audio analyzer 218 reads an audio file including a recorded livecast from a podcast data store 216. The audio analyzer 218 may also receive audio files as content streams from a streaming engine 214. Once a new audio file is received by the audio analyzer 218, it may be converted into an audio bitstream file format (e.g., WAV and the like) if not already received in this format from the streaming engine 214 and/or podcast data store 216. Extraction logic 220 may then slice the audio file into sections including dialogue and other spoken content. Sections of the audio file that do not include spoken content are excluded from the rest of the indexing process. Audio slices including dialogue are then transferred by extraction logic 220 from the audio analyzer 218 to an audio to text API 224 or other service for converting sound files including spoken words into text. The audio to text API 224 and/or the extraction logic 220 may then extract a playback timeline from the audio file and obtain timeline information that positions converted text on the playback timeline. In various embodiments, timeline information may be assembled by associating every word included in the text converted from the audio file with a location on the playback timeline that corresponds to the point in time during the livecast when the text was spoken. For example, if the sentence “I think technology will save the world” was spoken during the 25th minute of the livecast, the audio to text API 224 and/or extraction logic 220 will assemble timeline information including the text “I think technology will save the world” appearing at the 25th minute of the playback timeline.

Calibration logic 222 then calibrates the timeline information to precisely synchronize the converted text with the playback timeline and merges the calibrated timeline information for all the audio file slices into one audio to text index file. In various embodiments, calibration logic 222 may adjust the playback timeline included in timeline information generated by the audio to text API 224 and/or extraction logic 220 to resolve in accurate positioning of converted text. Calibration logic 222 may harmonize converted text results with the playback timeline by applying a scaling factor. In various embodiments, the scaling factor may correspond to a scaling rate determined by comparing the length of the audio file with the length of time taken to return the result of the audio to text conversion by the audio to text API 224 and/or the extraction logic 220. If the scaling rate is skewed toward the length of the audio file (i.e. the audio file is much longer than the time required to generate audio to text conversion results) the calibration logic 222 may calibrate timeline information by compressing the playback timeline by applying a scaling factor (e.g., a compression scaling factor having a value less than 1) to reduce the number of unique timeline positions available for placing words on the playback timeline. Compressing the playback timeline may improve the accuracy of text to audio indices generated from audio files including slowly spoken words and/or phrases and or long pauses between words, phrases, sentences, and the like. Compressing the playback timeline may also make generating text to audio indices more efficient without losing any of the spoken text. To resolve instances of audio files having sections that do not include spoken text, calibration logic 222 may instruct extraction logic 220 to re-slice the audio file to more precisely select the portions of the audio file containing spoken words before performing the audio to text conversion.

If the scaling rate is skewed toward the time required to generate conversion results, (i.e., the audio file is much shorter than the time required to generate audio to text conversion results) calibration logic 222 may calibrate timeline information by expanding the playback timeline to compensate for audio files including rapidly spoken words, phrases, dialogue and the like. Applying a scaling factor (e.g., an expansion scaling factor having a value greater than 1) to expand the playback timeline creates more unique playback timeline positions, thereby allowing more words to be placed in a unique timeline position on the playback timeline. By expanding the playback timeline for audio files including rapid and/or condensed speech, audio to text conversion may be more clear and the audio to text index more accurate while also ensuring text for all spoken words is included in the playback timeline.

After calibrating timeline information by calibration logic 222, playback timelines for each slice may be merged to create one timeline per livecast. Calibrated timelines including converted text associated with accurate livecast timeline locations may be written to an audio to text index data store 226. In various embodiments, the audio to text index data store 226 may be implemented as a local data store included in a server device 104 and/or one or more remote cloud storage instances. The audio to text index data store 226 may store index files in various ways including, for example, as a a flat file, indexed file, hierarchical database, relational database, unstructured database, graph database, object database, and/or any other storage mechanism.

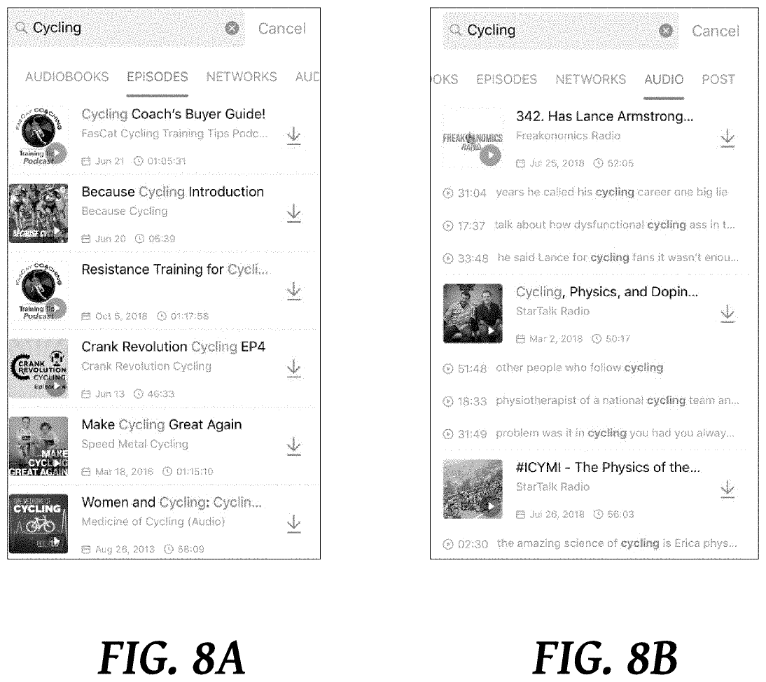

To provide in-audio search functionality an audio search API 228 references the index files included in the audio to text index data store 226. For example, to provide results for an in-audio search query including the term “technology”, the audio search API 228 searches index files included in the audio to text index data store 226 for livecasts including audio content including the word technology. In various embodiments, the audio search API 228 may provide the portion of the converted text including the search term(s) and the location (in hours, minutes, seconds, and the like) of the term on the livecast timeline as search results. To order results for terms having many in-audio hits, the audio search API 228 may use other factors to order the results, for example, how many times a term appears in the livecast, the density of the term in a particular livecast section, the number of plays the livecast has, the number of followers the livecast performer and/or channel has, and the like. Exemplary in-audio search results provided by the audio search API 228 are provided below in FIGS. 8A-B.

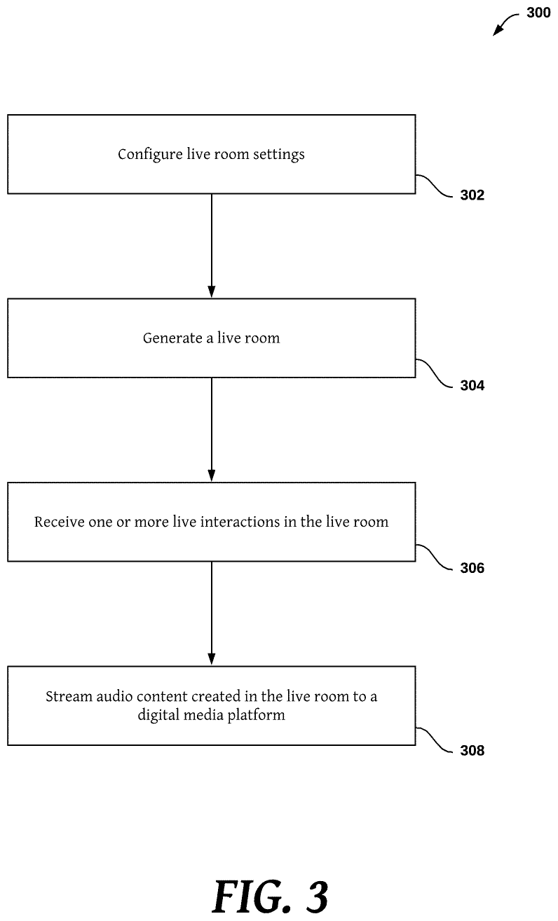

FIG. 3 illustrates an exemplary process for livestreaming content streams included in livecasts 300. In various embodiments, one or more livecast performers may customize the environment for creating audio content by configuring one or more live room settings, at step 302. The live room includes a connected digital space hosting a live audio performance and may be modified by the livecast agent according to the preferences of one or more audio content performers. For example live room settings (e.g., live room identification information, privacy settings, notification settings, and the like) may be configured to encourage or control access. Live room settings (e.g., explicit content settings, supported user interactions, and the like) may be configured to dictate the type of content created inside the live room. Live room settings (e.g., recording settings, indexing settings, and the like) may be configured to control distribution of recorded livecasts and other audio content created in a live room. Live room settings (e.g., schedule settings and the like) may be configured to auto-generate live rooms according to a fixed date and/or a reoccurring schedule to facilitate regular creation of livecasts and other audio content. At step 304, a livecast agent generates a live room according to the settings specified in the configuration step at 302. The live room may include connection information that allows community members to locate and access the live room. The live room may also include one or more content streams included in a livecast that can be distributed to community members that access the live room. Once a live room has been generated, performers and community members by join the live room that access livecast content streams and other audio content created in the live room. At step 306, community members may engage in live interactions with one or more livecast performers, other community members, and/or the content streams included in the livecast inside the live room. Live interactions received by the live room are shared among the livecast performers and the community members connected to the live room. For example, text messages received by the live room may be added to the live room content feed viewable by all performers and community members connected to the live room. Audio from call-ins accepted by the livecast performer is distributed to everyone connected to the live room. Virtual gifts received within the live room may create an animation visible inside the live room and a record (e.g., an image and/or icon representing the virtual gift) of the virtual gift received and the sender may be added to the live room content feed. At step 308, content created inside the live room including audio content performed by one or more livecast performers and live interactions received from community members and performers is livestreamed on a digital media platform. Community members browsing content on the digital media platform may discover the live room, locate the live room address, and join the live room to access the livecast content streams by using live room access information to establish a network connection between a digital media platform instance executed by a user device and a server device hosting the live room. Using a viewer built into a web and/or mobile application instance of the digital media platform, community members may receive livestreams of the content streams included in the livecast (e.g., audio streams, content feeds, video streams, and the like) and participate in live user interactions within the live room.

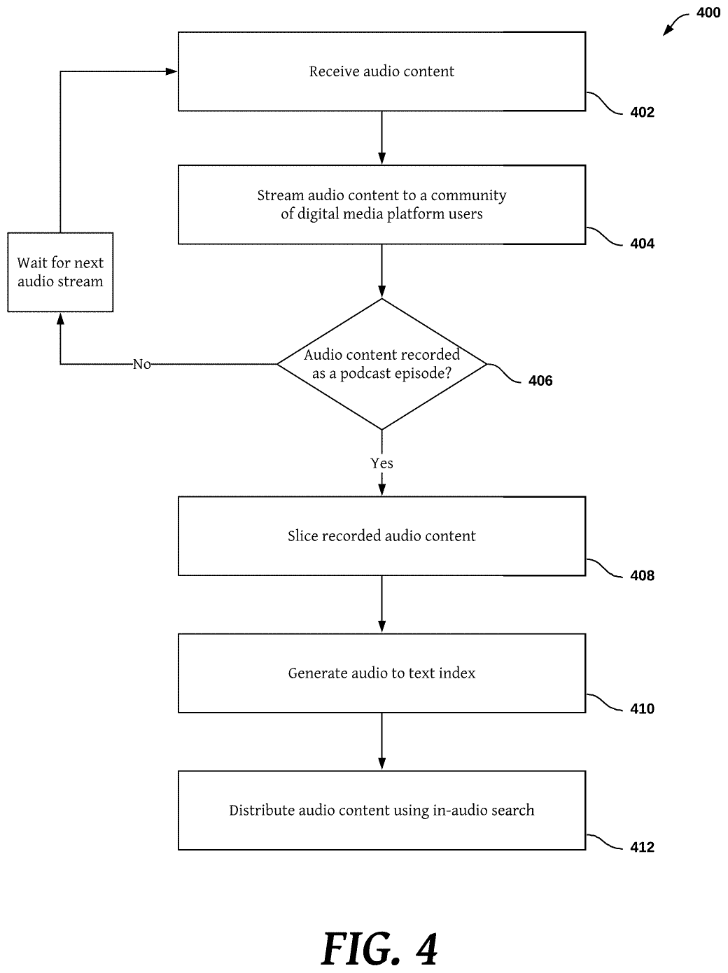

FIG. 4 illustrates an exemplary process for distributing recorded livecasts and other recorded audio content generated in a live room to a digital media platform 400. At step 402, a server device receives audio content including a livecast from a live room. At step 404, the server device livestreams audio content in the live room to a plurality of user devices by providing connection information for accessing a live room and one or more content streams including livecasts and other audio content created in the live room. Livecasts may include audio content created by one or more livecast performers and/or live user interactions received from community members and/or performers. In various embodiments, live user interactions may include audio visual content, for example, a live content feed including comments and/or virtual gift animation displayed in a live interaction GUI combined with audio content from a performer and or a community member engaging in an accepted call-in. Images, videos, audio clips, streaming audio visual content, and the like may be shared to the live content feed by performers and/or community members. If, at decision point 406, the live room providing the livecast was not configured to record audio content created in the live room, audio content included in the livecast is saved a draft but not further processed for distribution using in-audio search. In this instance the server device, may wait to receive the next audio content stream. If, at decision point 406, the live room providing the livecast and other audio content was configured to record audio content created in the live room, audio content including live user audio interactions (e.g., call-in interactions) may be processed for distribution using in-audio search. At step 408, the recorded audio content file is sliced to separate the portions of the audio content file including dialogue, lyrics, call-in interactions, and other spoken audio content from the portions of the audio content file that do not include spoken audio content. Slices including spoken audio content may be transferred to an audio to text API that converts spoken audio to text and assembles timeline information by placing the converted text on a timeline of the audio slice. In various embodiments, the timeline indicates the time (e.g., in seconds, minutes, hours, and the like) the text was spoken in the audio file. Depending on the cadence of the speaker, size of the slice, clarity of the spoken audio, and the like, the timeline may be calibrated to resolve inaccuracies in audio to text conversion and/or timeline information generation (e.g., placement of words in the converted text on the playback timeline). Using the converted audio text and the timeline information, an audio to text index is generated for the audio slices, at step 410. The audio to text index may include the converted text associated with a playback timeline location describing to the playback time within the audio file when the text was spoken. In various embodiments, the slices may be merged before and/or after generating the audio to text index to create one audio to text index for each livecast show recorded in an audio file provided by a live room. At step 412, audio content having an audio to text index may be distributed on a digital media platform using in audio search. In various embodiments, to deliver in-audio search query results, an in-audio search API searches a database of audio to text indexes to locate the indexed audio files having spoken audio including one or more keywords identified in the search query. The in-audio search API may then return the titles of the audio files including the search terms and the converted audio text timeline showing the playback time within the audio file when the search term was spoken. In various embodiments, livecast episodes including live user interactions (e.g., call-in interactions) may be indexed for in audio search using the steps described above to generate an audio to text index for the livecast that enables in-audio search on the live user interactions. Accordingly, words spoken in the live user interactions may be searched using the in-audio search API. The in-audio search API may incorporate other weighting factors, for example, the number of times the searched keyword appears in the audio to text index, the number of plays the audio file has, the number of followers the channel publishing the audio file has, and the like to order results for queries generating more than one hit.

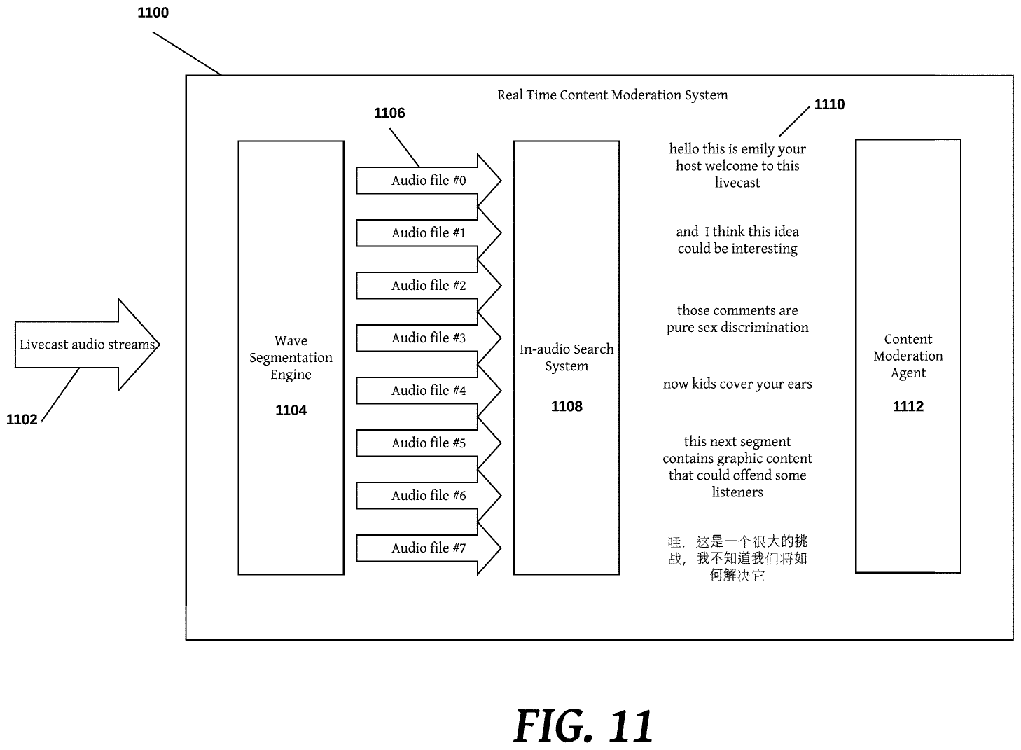

Audio to text indices generated by the audio analyzer may be used in content moderation techniques. Live streaming allows users to stream content to a listening audience in real time. For large platforms with millions of users, reviewing all of the content streamed on the platform to verify it adheres to the rules of the platform is time consuming and expensive. Global platforms must also review content in different languages and content streamed during all 24 hours of the day. The real time content moderation system 1100 disclosed below in FIG. 11 can help manage content review by removing language barriers and ensuring the review process is executed continuously at all hours. The real time content moderation system 1100 can also reduce the time and expensive of content moderation while also improving accuracy and reliability of content alternations.

As shown in FIG. 11, the real time content moderation system 1100 may include a wave segmentation engine 1104, an in-audio search system 1108 and a content moderation agent 1112. The wave segmentation engine 1104 may ingest livecast audio streams 1102 in real time to generate audio flies 1106 that segment the streaming audio into a sequence of audio clips that may be processed by the in-audio search system 1108. The length, size, and/or format of the audio files 1106 generated by the wave segmentation engine 1104 may be optimized for processing by the in-audio search system 1108. In various embodiments, the audio files 1106 may within the range of 30 seconds to 120 seconds to allow for near real-time processing by the in-audio search system 1108. Real time performance of the in-audio search system 1108 may be optimized by reducing the length of the audio files further, however, files at least 30 seconds in length are needed to generate meaningful phrases from the audio that may be converted into text by the in-audio search system 1108. Audio files 1106 generated by the wave segmentation engine 1104 may include 5 seconds or more overlap between consecutive audio files generated for the same livecast audio stream. This overlap is required to optimize the audio files for efficient processing by the in-audio search system 1108. In various embodiments, the in-audio search system 1108 may be unable to accurately convert dialogue to text for dialogue included in at the boundaries of the audio files 1106 (e.g., the last five second of audio and the first five seconds of audio included in two consecutive audio files). The in-audio search system 1108 may not accurately convert dialogue into text at transitions between audio files because the context of the phrase is lost when the first file truncates and the second file begins.

To generate audio files having clean transitions (e.g., end on a sentence of thought), the wave segmentation engine creates an overlap between consecutive audio files. The overlap provides context required by the in-audio search system 1108 to accurately convert the audio into text. In various embodiments, the overlap may provide extra dialogue for the in-audio search system to consider when converting audio into text. In various embodiments, the overlap, may help the in-audio search system 1108 recognize audio files 1106 generated from the same livecast audio stream. By using the overlap to associate audio files 1106 generated from the same livecast, the in-audio search system 1108 may use the context of previously processed livecast audio files when converting dialogue to text for new audio files generated from the livecast audio stream. In various embodiments, the wave segmentation engine 1104 and/or the in-audio search system 1108 may cut the beginning and/or the end portion of the audio file to optimize one or more processing steps required to covert audio to text. The overlap portion may correspond to the length cut required for optimization thereby ensuring the entire dialogue portion is converted into text.

The in-audio search system 1108 generates text snippets 1110 from the dialogue and other spoken content included in the audio files 1106. The text snippets 1110 may include a series of comprehensible phrases converted from dialogue included in the audio files 1106. In various embodiments, the in-audio search system 1108 may generate text for multi-lingual audio streams. Dialogue may be converted to the text of the language it is spoken. For example, dialogue spoken in English may be converted to English text, dialogue spoken in Chinese may be converted to Chinese text, dialogue including both English and Chinese may be converted to English text for the portions spoken in English and Chinese text for the portions spoken in Chinese, and the like.

The content moderation agent 1112 processes text snippets 1110 generated by the in-audio search system 1108 to identify content that does not comply with the rules of the platform. In various embodiments, the content moderation agent 1112 may implemented a tiered approach to reviewing content included in livecast audio streams. In the first tier of analysis, the content moderation agent 1112 identifies content that may contain inappropriate content and requires additional review. The content moderation agent 1112 may perform the first tier of analysis by using a rules based inappropriate content classification machine learning model trained on a dataset including a dictionary and/or thesaurus of inappropriate words and/or phrases (e.g., words and/or phrases identified as descriptive of grotesque, exploitative, illegal, exhaustingly hateful, and the like situations and/or events that if incorporated into audio content would likely cause the audio content to violate the rules of the platform). Words and/or phrases incorporated into the dataset for training the content classification model may be specific to the context of the text snippet (e.g., the category of content the livecast is published under or tags added by the host). The content moderation agent 1112 by execute the inappropriate content classification model on the text snippets 1110 to generate a classification prediction as output that predicts the likelihood the snippet includes inappropriate content. The classification prediction may include a numerical value that is compared to an inappropriate content threshold. In various embodiments, the inappropriate content threshold may be dynamically weighted to reflect current events. For example, the inappropriate content threshold may more heavily scrutinize text snippets 1110 having key words distilled from recent news articles and or content removed from other platforms describing one or more events that occurred recently (e.g., an act of violence or exploitation). Text snippets 1110 having inappropriate content predictions failing (e.g., are above) the inappropriate content threshold may be saved for further content moderation analysis and text snippets having inappropriate content predictions passing (e.g., are below) the inappropriate content threshold may be considered appropriate by the real time content moderation system and excluded from further analysis.

The text snippets 1110 classified as likely to contain in appropriate content may be further analyzed in a second tier of analysis performed by the content moderation agent 1112. The second tier of analysis may predict if the text snippet 1110 including the inappropriate trigger word(s) or phrase(s) expresses an inappropriate opinion and/or describes an inappropriate event or concept that violates the rules of the platform. One or more machine learning models may be used by the content moderation agent 1112 to perform the second tier of analysis. In various embodiments, a semantic classification model may determine if a text snippet expresses an inappropriate opinion and/or describes an inappropriate event or concept that violates the rules of the platform. The semantic classification model may be a deep learning model trained using a first dataset including a selection of labeled data including examples of text labeled as violating platform rules and examples of text labeled as not violating platform rules. Content removed from platforms external to the digital media platform (e.g., social media platforms including Facebook, Twitter, Youtube, and the like) may be included in the first training dataset.

To improve performance of the semantic classification model, the semantic classification model may be trained in an additional training iteration using a second training dataset. Feedback on the performance of the semantic classification model received from users of the digital media platform may be incorporated into the second training dataset. Examples of incorrectly classified and correctly classified text snippets 1110 may be included in the second training dataset. For example, text snippets 1110 referenced in complaints received from users identifying livecasts including content violating platform rules that were not removed by the real time content moderation system 1110 may be labeled as incorrectly classified. Text snippets 1110 included in livecasts removed from the digital media platform manually that were not removed by the real time content moderation system 1110 may also be labeled as incorrectly classified and included in the second training set. Text snippets included in livecasts that were modified and/or removed with no complaints post removal and/or modification may be labeled as correctly classified and incorporated into the second training set. The labeled data may be assembled from actual dialogue that has been found to violate and/or not violate platform rules and/or hypothetical examples. The dataset may be label manually using human review and/or using an automated method. To achieve higher classification accuracy and recall rate, the semantic classification model may be updated by retraining on new iterations of the first training dataset and/or the second training dataset.

In various embodiments, the content moderation agent 1112 can modify content classified as inappropriate by the semantic classification model. For example, the content moderation agent 1112 may permanently and/or temporarily remove livecasts classified as inappropriate. The content moderation agent 1112 can sensor the livecast by removing the text snippet classified as inappropriate. Analysis performed by real time content moderation system 1110 may occur in real time allowing the content moderation agent 1112 to stop and/or suspend the livecast audio stream in response to a determination of inappropriate content made by the semantic classification model. The content moderation agent 1112 may also remove and/or modify previously recorded content including livecasts published on the digital media platform based on a determination of inappropriate content made by the semantic classification model.

FIGS. 5A-K illustrate exemplary live room setup and livecast sharing GUIs that may be provided by a livecast agent to facilitate configuring a live room and sharing livecast content. FIGS. 5A-B illustrate exemplary live room setup GUIs for configuring live room settings. FIGS. 5C-E illustrate exemplary live room setup GUIs for scheduling auto-generation of a live room. FIGS. 5F-G illustrate exemplary live room notifications that may be shared to one or more social media platforms. FIGS. 5H-J illustrate exemplary livecast sharing GUIs for creating livecast sharing notifications with an embedded playback position.

FIG. 5A illustrates an exemplary live room setup GUI including a performer profile. Performer profile information shown towards the top of the GUI may include performer name, photo, number of fans, and the number of performers followed by the performer. Users may access the personal profile shown in the setup GUI of FIG. 5A by selecting the highlighted personal icon in the lower portion of the personal profile. Various aspects of a digital media platform of accessible from the performer profile including: functionality for recording a podcast; a file including previously recorded podcasts, livecasts, and other audio files; a digital wallet including digital currency bought and/or earned on the digital media platform; and an inbox contain messages received through the digital media platform. In various embodiments, a live room may be generated from the performer profile by selecting the livecast icon in an upper portion of the live room setup GUI shown in FIG. 5A. To help distinguish the livecast icon, FIG. 5 includes an rectangular outline around the livecast icon with an arrow from the livecast icon to the live room setup GUI shown in FIG. 5B. Selecting the livecast icon in the performer profile navigates to a live room configuration page included in the live room setup GUI shown in FIG. 5B. The live room configuration page may capture livecast identification information generated by a performer and one or more settings for the live room. As shown in FIG. 5B, performers may enter a title for the livecast in the top portion of the live room configuration page and select a cover image displayed next to the title. One or more hashtags (e.g., searchable keywords describing the livecast) and/or greetings to other performers and/or community members joining the live room may be may be entered in the top portion of the live room configuration page. Settings icons displayed toward the middle of the live room configuration page allow performers to configure live rooms.

In the live room setup GUI shown in FIG. 5B, performers may configure: notification settings by selecting the bell icon; explicit content setting by selecting the explicit “E” icon; privacy settings by selecting the eye icon; and recording settings by selected the record icon. In various embodiments, selecting the notification icon may send a notification to all community members and/or fans following a performer when a performer schedules and/or begins a livecast. Not selecting the notification icon may not automatically send fan and/or follower notifications. Selecting the explicit “E” icon may alert all performers and/or community members joining a livecast that the livecast contains explicit content by labeling the livecast as explicit on the livecast browsing page and/or sending an explicit content warning to community members when they join the live room. Not selecting the explicit “E” may not automatically alert performers and/or community members joining a livecast that the livecast contains explicit content. Selecting the eye icon may display the livecast in a public livecast browsing page included in a digital media platform. Any user on the digital media platform may access public livecasts displayed on the livecast browsing page. Not selecting the eye icon may configure the live room as a private live room that may not be displayed on a public livecast browsing page within a digital media platform. Only performers and community members invited to join the livecast by one or more performers may access private live rooms. Selecting the record icon may automatically record the livecast for replay and uploading to a podcast and/or performer channel. Not selecting the record icon may not automatically record the livecast and performers may have to specify they want to save the livecast after the live room is closed in order to obtain a recorded copy of livecast audio content. After selecting settings icons to configure the live room and entering livecast identification information, a performer may select a start now button at the bottom of the configuration page to begin a livecast. Selecting the schedule button at the bottom of the configuration page may navigate to the live room setup GUIs shown in FIGS. 5C-E to enable performers to schedule generation of a live room having the settings and livecast identification information captured by the configuration page included in the live room setup GUI shown in FIG. 5B.

FIG. 5C illustrates an exemplary live room setup GUI including a configuration page having the schedule button outlined. Selecting the schedule button may navigate to the live room setup GUI shown in FIG. 5D. Identification information for an upcoming livecast is shown in the scheduling page included in the live room setup GUI illustrated in FIG. 5D. Identification information may include the date and time of the scheduled livecast and a description of the performer and/or podcast channel generating the live room as well as some of the available features of the livecast and the performer hosting the livecast. The upcoming schedule for future shows may also be displayed in a lower portion of the scheduling page. More than one livecast may be scheduled from the live room setup GUI illustrated in FIG. 5D by selecting the arrow next to “Next Live” at the top of the GUI. In various embodiments, selecting the arrow will navigate to a new scheduling page for scheduling a different livecast. To schedule another livecast, performers may fill out information included in the new scheduling page. In various embodiments, some fields of the scheduling page will auto-populate, for example, the description information (e.g., the performer/podcast description, livecast description, host, time, and the like) allowing performers to schedule a new livecast by selecting only a date and time. In various embodiments, performs may customize auto-populated description information and/or enter their own description information into a blank description field. Selecting a “SAVE” button in a top section of the scheduling page may schedule a livecast and/or navigate to the live room setup GUI shown in FIG. 5E. Once a livecast is scheduled, a live room setup GUI including a livecast schedule page as shown in FIG. 5E may be generated. The livecast schedule page may include the description information and livecast schedule captured in the schedule page included in the live room setup GUI shown in FIG. 5D. The livecast schedule page may also include a notification icon. In various embodiments, selecting the notification icon may send a notification to performer and/or community member at or before the livecast starts (e.g., when the livecast starts, fifteen minutes before the livecast starts, the day of the livecast, the day before the livecast, and the like). Performers and/or community members may access the livecast schedule page by selected a scheduled livecast displayed a livecast browsing page, an upcoming livecast page, a performer page, a podcast channel page, and similar pages included in a digital media platform. In various embodiments, selecting the notification icon may also add a livecast as an calendar event on a digital calendar for example, Apple iCal, Microsoft Outlook calendar, Google calendar, and the like.

FIG. 5F-G illustrate exemplary notifications that may be generated for live rooms configured to generate notifications during live room configuration. Notifications may be delivered directly to a user device, sent to a performer of community member on a digital media platform, shared on a social media platform, and the like. FIG. 5F illustrates an exemplary notification generated to share a livecast on Twitter. The notification may include a user call to action to join a livecast on a digital media platform, a brief description of the livecast content, a live room address, and a link to access the live room. FIG. 5G illustrates an exemplary notification generated to share a livecast on Facebook. The notification may include a user call to action to join a livecast, a description of the features available in a livecast and a link to access the live room. In various embodiments, notifications may be generated by a livecast agent via communications with one or more social media platform content sharing APIs. The social media content sharing APIs may provide instructions for formatting a post on the social media platform and an address to send data and message to a social media platform sever in order to share the message on the social media platform.

In various embodiments, a portion of the content included in the notifications shown in FIGS. 5F-G may be automatically generated by the livecast agent, for example, the live room address, livecast description, the link to the digital media platform, and the like. To post a notification on a social media platform, the livecast agent may send automatically generated content to a social media platform API which may create the notification include in the automatically generated content and/or post the notification to the social media platform upon receive a post, tweet, share, and the like command from a user.

Notifications generated by the livecast agent may include a position within the timeline of a livecast. Accessing the livecast using a link including a position will begin playback of the livecast at the position referenced in the notification. Sharing a particular position within a livecast allows listeners, audience members, and performers to emphasize and communicate particular aspects of the livecast that they find interesting or important. In various embodiments, the livecast agent may embed the playback position into the livecast link by appending the timeline position to the livecast link within the notification. For example, a notification may comprise text: “hey checkout my question on the podbites podcast” followed by a link to the livecast show referencing a particular timeline position. These notifications may facilitate more user interaction and engagement with audio content on a digital media platform by allowing users to share precise segments of a livecast that include their favorite moments. By including playback positions in notifications, the livecast agent may allow users of platforms outside of the digital media platform (e.g., social applications, messaging applications, and the like) to access content mentioned on the notification faster while using less compute, memory, and networking resources. For example, playing back the livecast at the referenced position instead of at the beginning of the livecast avoids compute, memory, and networking resources required to stream the entire livecast, search through the livecast to find the position discussed in the notification, and/or message the user submitting the notification to get more information about the portion of the livecast discussed.

FIGS. 5H-K are example exemplary GUIs from creating a notification including a playback position within a livecast. Selecting a share icon may generate the livecast sharing GUI including the share with position option, as shown in FIG. 5H. Users may generate notifications including playback positions by selecting the “share episode with position” button. Users may select a position to share within the livecast by adjusting the playback timeline at the bottom of the playback GUI shown in FIG. 5I. Once a playback position is selected, the livecast agent may embed the playback position within the share livecast link by appending timeline information (e.g., “t=25.13” for timeline position 25 min and 13 seconds) to the livecast link. FIG. 5J illustrates an exemplary livecast link including an embedded playback position. After generating a livecast link including an embedded playback position, users may select an application to share the link to from the platform selection GUI shown in FIG. 5K. Selecting a platform to the share the livecast link including the embedded playback position may generate a notification formatted for the selected platform that includes the livecast link with position. The livecast agent may access platform specific notification formatting specifications by communicating with a platform sharing API for the selected platform. In various embodiments, selecting a platform within the platform selection GUI may open an instance of the selected platform and display the generated notification with a livecast link including position. Users may then edit the notification contents within the selected platform before sharing the notification on the platform.

FIGS. 6A-J illustrate exemplary live interaction GUIs for sending and/or controlling live interactions sent by performers and/or community members to a live room. FIGS. 6A-D illustrate exemplary live interaction GUIs for text message and call-in live interactions. FIGS. 6E-F illustrate exemplary live interaction GUIs for virtual gift live interactions. FIGS. 6G-6J illustrate exemplary playlist interaction GUIs for sharing audio files within a live room.

FIG. 6A illustrates a live interaction GUI including a live content feed. In various embodiments, the live content feed may display text messages and/or virtual gifts sent to the live room my one or more performers and/or community members. The exemplary live content feed shown in FIG. 6A displays for entries including, from top to bottom, an explicit content notification, a message from a performer, and two text message live interactions from community members. To submit a live text message live interactions to a live room during a live cast, performers and/or community members connected to live room may select the dialogue bubble message icon included in a bottom portion of the content feed. Selecting the message icon may generate a free form text input box to capture a text message. Entering text into the text box and sending a post command may send a live text message user interaction to a live room and add the text message to the live content feed in real time. In various embodiments, performers may have control over the content created in the live room. For example, a performer may remove a comment from the live content feed. Performers may also control community members that may join the live room and access the livecast. In various embodiments, a performer may get more information about a community member connected to the live room by selecting the community member cover photo in a top portion of the live interaction GUI shown in FIG. 6A. Selecting a community member cover photo may navigate to a community member profile page included in the live interaction GUI shown in FIG. 6B. From the profile page, a performer may add a comment about the community member and/or remove the community member from the live room by selecting the three dot icon in a top portion of the profile page. In various embodiments, selecting the three dot icon will generate block and/or unblock buttons. Selecting the block button may block the community member described in the community member profile page and remove the community member from the live room. Blocking a community member may also prevent that community member from rejoining the live room for the current livecast and all other subsequent livecasts performed by that performer.

To access a call-in live interaction, a community member may select the phone icon at the bottom of the content feed. Selecting the phone icon may generate the live interaction GUI shown in FIG. 6C that includes the call-in button. Selecting the call-in button may allow a community member to send a call-in communication to the live room. Live room call-in communications may show up on a performer call management popup screen included in the live interaction GUI shown in FIG. 6D. If more than one community member submits a call-in communication to a live room, each community member calling in will be down in the performer call management popup screen. A performer may disable and/or enable a call-in live interactions by moving the slider in the top portion of the performer call management popup screen. When call-in live interaction are enabled, community members submitting call-in communications may have an answer phone icon next to their cover photo. To answer the call-in communication and provide a live audio stream within the live room to the community member, the performer selects the answer phone icon for the community member she wishes to accept the call-in communication. Once a call-in communication is accepted, a user may have an live audio interaction within the live room and the community members audio feed will be streamed to the performer and all community members connect to the live room. Accepting a call-in communication may change the icon next to the cover photo of the community member from the answer phone icon to the hang up icon. To end a call-in interaction, stop streaming the community member's audio feed a performer may select the hang up icon. Performers may also mute their own microphone by selecting the mute icon below the content feed shown in FIG. 6A. Selecting the three line icon in the content feed will allow the performer to select additional control functions. Including blocking community members, adding community members to the admin list, sending notifications to community members, changing one or more live room settings, and making the livecast pubic and/or private. In various embodiments, making a community member and admin allows the community member to remote comments from the content feed, block community members, accept or end call-in communications, and the like.

FIG. 6E illustrates a live interaction GUI including a gift selection screen. Community members connected to a livecast may send a virtual gift to the live room as a reward for the performer and/or sign of support for the livecast content. Virtual gifts may be associated with an actual monetary value and, therefore, may provide a more efficient way to compensate performers for creating livecast content than conventional payment mechanisms. In various embodiments, gifts may be purchased by community members using digital currency obtained on a digital media platform. To obtain digital currency users may purchase digital currency using an e-commerce component built into the digital media platform and/or earn digital currency for performing tasks on the digital media platform (e.g., reviewing content, moderating livecast rooms, creating content, watching advertisements, and the like). Each unit of digital currency may have a corresponding value in real currency. The amount of units of digital currency available for each unit of real currency may be referred to as an digital currency exchange rate that may be variable and/or fixed. Digital currency may be purchased on the digital media platform and/or other mobile or web based applications having a compatible digital currency using any real currency (e.g., fiat money, US Dollars. EU Euros, British Pounds sterling, Chinese RMB, and the like). Digital currency on the digital media platform may be stored in a digital wallet (e.g., a digital wallet accessible from the personal profile shown in the setup GUI of FIG. 5A). As shown in the gift selection screen in FIG. 6E, virtual gifts may cost different amounts of digital currency. For example, a clap gift may cost 1 coin of digital currency, a cupcake gift may cost 15 coins, a golden microphone gift may cost 100 coins, and the like. Community members may not purchase gifts that cost more than the amount of coins in their digital wallet. To purchase a more expensive gift, a community member may have to first purchase additional coins to add to his digital wallet.

To send a digital gift to a live room, community members may select a virtual gift to the send using the gift selection screen shown in FIG. 6E. Once a gift is selected, pressing the send button may send the virtual gift to the live room. In various embodiments, when the live room receives a virtual gift an gifting animation may be displayed on the live content feed. FIG. 6F, for example, illustrates a live interaction GUI including a live content feed displaying a cupcake gifting animation. As shown in FIG. 6F, the gifting animation may including displaying many images of the virtual gift over the content feed. In various embodiments, the virtual gift images may move within the live interaction GUI, for example, explode from one central location at the bottom of the content feed and float slowly to the top while fading from view at various locations between the top and/or bottom of the content feed. The gifting animations may enhance the entertainment experience of the content feed in the live room by adding exciting and/or visual aspects to augment the audio content performed by the livecast performers and the other live interactions with community members. The gifting animations may also notify one or more performers that they have received a gift so that the performers may acknowledge the community member giving the gift and/or receive confirmation that a community member has given the gift he promised in a live interaction (e.g., in an live call-in audio message and/or a text message sent to the content feed).

In various embodiments, each virtual gift given to a live room adds the amount of digital currency corresponding to the cost of the virtual gift to the performers digital wallet. For example, if during a livecast performance, 2 cupcake virtual gifts and 2 golden microphone virtual gifts were sent to a live room, 230 digital currency coins may be added to the performers digital wallet. The performer may use the digital currency earned during the livecast on the digital media platform (e.g., to give to performers of other livecasts by sending virtual gifts to their live rooms). The performer may also “cash out” the digital currency in her wallet by exchanging the digital currency for real currency. In various embodiments, the digital media platform may set a cash out exchange rate determining how much each unit of digital currency in the performer's wallet is worth in real currency. For example, a cash out rate of 10 digital currency coins to 1 real currency unit (e.g., US dollars) would be mean the performer could cash out the 230 digital currency coins earned during the livecast for $2.30 USD. The cash out rate may not be equal to the so that the digital currency exchange rate on the digital media platform. For example, the cash out rate may be 10 digital currency coins to 1 real currency unit and the digital currency exchange rate may be 5 digital currency coins to 1 real currency. Therefore, community members may have collectively paid $4.60 for the 230 coins required to purchase the 2 cupcake virtual gifts and the 2 golden microphone gifts, but the performer could only cash out $2.30. The difference between the $4.60 virtual gift purchase price and the $2.30 cash out price may be kept by the digital media platform as profit and/or distribution to community members and/or performers. After a performer has cashed out digital currency coins from her digital wallet number of coins in her digital wallet may be reduced by the number of cashed out coins. In various embodiments, the cash out feature allow performers to make real money from creating entertaining livecast content in live rooms. It also provides a mechanism for community members to pay real money for live audio content accessed through one or more live content streams provided by a live room.

FIGS. 6G-J illustrate playlist interaction GUIs for sharing audio files to a live room. Audio files added to the playlist may be played in a live room during a livecast at the discretion of the livecast host while the host is broadcasting the livecast in real time. The live playlist interaction allows livecast host to develop more engaging content within the live room by providing a list of 30 or more audio files for playback during the livecast broadcast. Audio files may include songs, sound effects, monologue clips, dialogue clips, and the like. For example, a host may play a portion of a song as an intro to the beginning of the livecast then play one or more sound effects during a monologue and/or conversion during the livecast to emphasize or enhance a particular comment and/or point made during that segment. By aggregating multiple types of audio files in one playlist available for playback at any time during the livecast, the playlist interaction allows host to create more engaging content by adding audio interactions to the livecast in real time without having to access, stream, and/or playback the audio content from a source external to the live room. By integrating the audio files included in the playlist into the live room, the playlist interaction also improves the quality of the audio content included in the livecast. The playlist interaction preloads audio files included in the playlist into the live room thereby ensuring clear playback and eliminating reliance on speaker and/or microphone hardware external to the digital media platform.

FIG. 6G illustrates and exemplary livecast content feed including a selectable playlist icon (e.g., a musical note) toward the bottom of the content feed. Selecting the playlist icon may navigate to a playlist creation GUI shown in FIG. 6H. Hosts may add audio files to the playlist by selecting an “add new song” button included in the playlist creation GUI and uploading audio files to the digital media platform live room. Once uploaded to the live room audio files may appear playlist interaction GUI shown in FIG. 6I. While live streaming a livecast within a live room, a host may play one or more audio files shown in the playlist interaction GUI by selecting the audio file. Only audio files uploaded to the live room are displayed in the playlist interaction GUI and a host may add or remove audio files from the playlist at any time during livecast. In various embodiments, playlists may be static elements of live rooms so the playlist and the audio files uploaded into the playlist will always be accessible whenever the host joins the live room. Therefore, the host does not have to re-upload the same audio files to the playlist every time they join the live room or create a livecast. Audio files may be deleted from playlists using the playlist management GUI shown in FIG. 6J. In various embodiments selecting a delete button (e.g., a trash can icon) removes the audio file from the playlist.

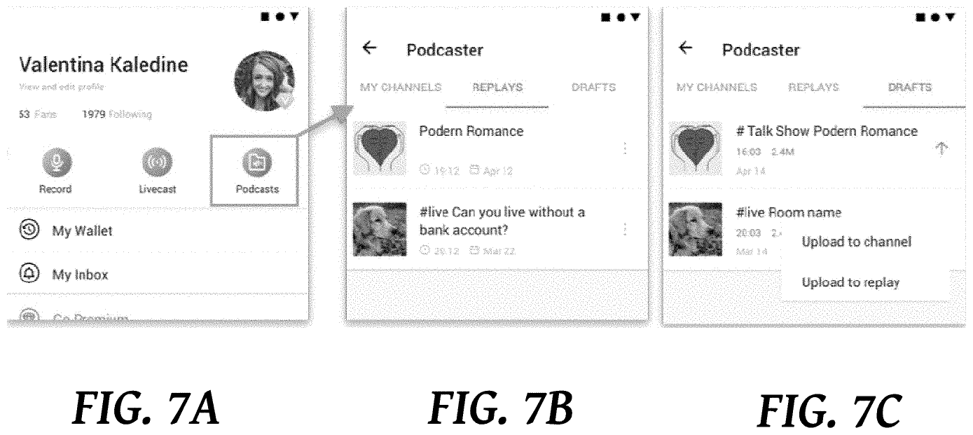

FIGS. 7A-C illustrate upload GUIs for distributing recorded livecast shows on a digital media platform. 7A illustrates an upload GUI including a personal profile. By selecting the auto record setting when configuring a live room, performers can have audio content included in livecasts automatically uploaded to the drafts library shown in FIG. 7C. Livecasts, included in the drafts library may then be uploaded to the replay library shown in FIG. 7B or added to the performer's channel. In various embodiments, livecasts added to the performer's channel will be automatically indexed for in-audio search by the digital media platform. Livecasts added to the performer's channel may be publically accessible to anyone browsing the digital media platform. Livecasts added to the replay library may be accessible to the performer only but may be saved permanently on the digital media platform. In various embodiments, livecasts saved in the drafts library may be deleted from the drafts library manually by the performer and/or automatically by the digital media platform after a period of time.

FIGS. 8A-B illustrate example in search GUIs displaying text search and in audio search results. FIG. 8A illustrates text search results returned from an episode title search of the keyword “cycling”. As shown in FIG. 8A, the text search results may return a list of audio content files having the term “cycling” somewhere in the title. FIG. 8B illustrates in-audio search results returned for the same search term, “cycling”. As shown in FIG. 8B, The in-audio search results may return a list of audio content files having the term “cycling” somewhere in the spoken audio included in the audio file. The results may also include the title of the audio content file, the performer and/or channel creating the audio content file, and/or in-audio excerpts. In various embodiments, in-audio excerpts may include converted text and timeline information found in the audio to text index for the audio content file. As shown in FIG. 8B, the in-audio excepts may include a section of audio file dialogue containing the search term converted into text and the timeline location when the dialogue containing the search term was spoken. For example, the phrase “other people who follow cycling” under the second audio content file listed in the in-audio search results may appear next to the timeline location 51:48 because the term “cycling” in the phrase, “other people who follow cycling” was spoken 51 minutes and 48 seconds into the audio file. Therefore, if, during playback of the audio file, the playback timeline was set to 51:48 the term “cycling” included in the phase “other people who follow cycling” would be audible.

In audio search allows community members to precisely search for interesting content when browsing audio files on the digital media platform. In audio search provides a unique way of searching audio content to determine exactly what terms are discussed and when the terms are discussed. In-audio search techniques are much more efficient than audio content file metadata searching (e.g., the title keyword results shown in FIG. 8A) because it enables users to search the content itself instead of relying on metadata descriptions which can be misleading and incomplete. By providing timeline information associated with the search results, in-audio search techniques greatly speed up the search process for users that want to listen to how the audio sounds before deciding to listen to the content. For some listeners, knowing what the audio content is about may not be enough to make a decision to listen or not. Other features including the performer's tone of voice, accent, and/or sound quality of audio file may be important. The timeline information provided in the in-audio search results makes the process of generating an audio preview during the content search process much faster and more efficient because it provides users with the timeline of the section(s) of the audio file that include the subjects they are interested in therefore users can select the most interesting portion of the audio file to preview when searching for audio content. In-audio search may be used to discover livecast shows and other audio content by enabling the dialogue of recorded livecasts including performer dialogue and call-ins from community members in the live room to be searched. Using timeline information sections of livecasts and other audio content including live interactions related to a user's subject matter interests may be found quickly using the timeline information returned in-audio search results. Therefore, community members may use the in-audio search feature to efficiently discover livecasts that include topics of interest, stimulating user interactions, accessible performers, supportive community members, high sound quality, and other favorable characteristics. In-audio search functionality also gives performers a platform for content distribution that enables high precision search and discovery of content they create. In various embodiments, in-audio search may make marketing a particular audio file easier by making the particular file discoverable using one unique term included in the audio rather than having to know the exact title, creation date, or episode number. Therefore in-audio search brings in-audio content files to a wider audience in a more efficient manner than conventional search techniques.

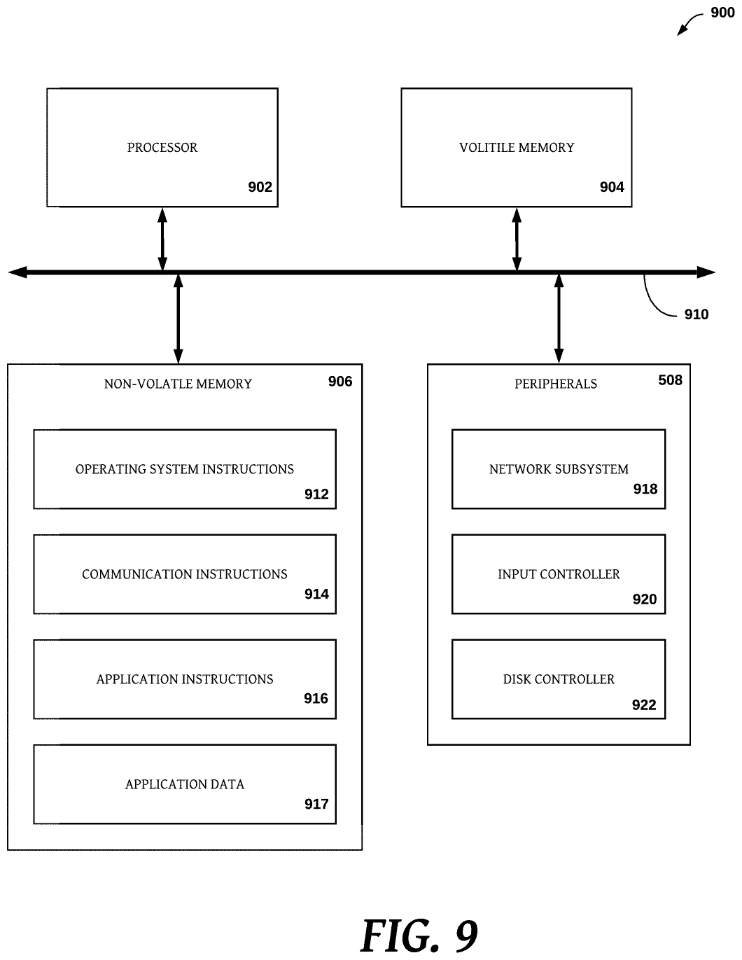

FIG. 9 shows an illustrative computer 900 that may implement the livecast system and various features and processes as described herein. The computer 900 may be any electronic device that runs software applications derived from compiled instructions, including without limitation personal computers, servers, smart phones, media players, electronic tablets, game consoles, email devices, etc. In some implementations, the computer 900 may include one or more processors 902, volatile memory 904, non-volatile memory 906, and one or more peripherals 908. These components may be interconnected by one or more computer buses 910.

Processor(s) 902 may use any known processor technology, including but not limited to graphics processors and multi-core processors. Suitable processors for the execution of a program of instructions may include, by way of example, both general and special purpose microprocessors, and the sole processor or one of multiple processors or cores, of any kind of computer. Bus 910 may be any known internal or external bus technology, including but not limited to ISA, EISA, PCI, PCI Express, NuBus, USB, Serial ATA or FireWire. Volatile memory 904 may include, for example, SDRAM. Processor 902 may receive instructions and data from a read-only memory or a random access memory or both. The essential elements of a computer may include a processor for executing instructions and one or more memories for storing instructions and data.

Non-volatile memory 906 may include, by way of example, semiconductor memory devices, such as EPROM, EEPROM, and flash memory devices; magnetic disks such as internal hard disks and removable disks; magneto-optical disks; and CD-ROM and DVD-ROM disks. Non-volatile memory 906 may store various computer instructions including operating system instructions 912, communication instructions 914, application instructions 916, and application data 917. Operating system instructions 912 may include instructions for implementing an operating system (e.g., Mac OS®, Windows, or Linux).

The operating system may be multi-user, multiprocessing, multitasking, multithreading, real-time, and the like. Communication instructions 914 may include network communications instructions, for example, software for implementing communication protocols, such as TCP/IP, HTTP, Ethernet, telephony, etc. Application instructions 916 can include instructions for generating a live room, configuring a live room, live streaming one or more content streams included in a live room, indexing one more audio files for in-audio search, and providing in audio search results as described herein. For example, application instructions 916 may include instructions for agents to generate and configure live rooms and distribute content created in live rooms as described above in conjunction with FIG. 1. Application data 917 may correspond to data stored by the applications running on the computer 900. For example, application data may 917 may include communication information, content metadata, content streams, live room settings, text to audio indices, performer profile information, and/or community member profile information.

Peripherals 908 may be included within the computer 900 or operatively coupled to communicate with the computer 900. Peripherals 908 may include, for example, network interfaces 918, input devices 920, and storage devices 922. Network interfaces 918 may include, for example, an Ethernet or WiFi adapter for communicating over one or more wired or wireless networks. Input devices 920 may be any known input device technology, including but not limited to a keyboard (including a virtual keyboard), mouse, trackball, and touch-sensitive pad or display. Storage devices 922 may include one or more mass storage devices for storing data files; such devices include magnetic disks, such as internal hard disks and removable disks; magneto-optical disks; and optical disks.

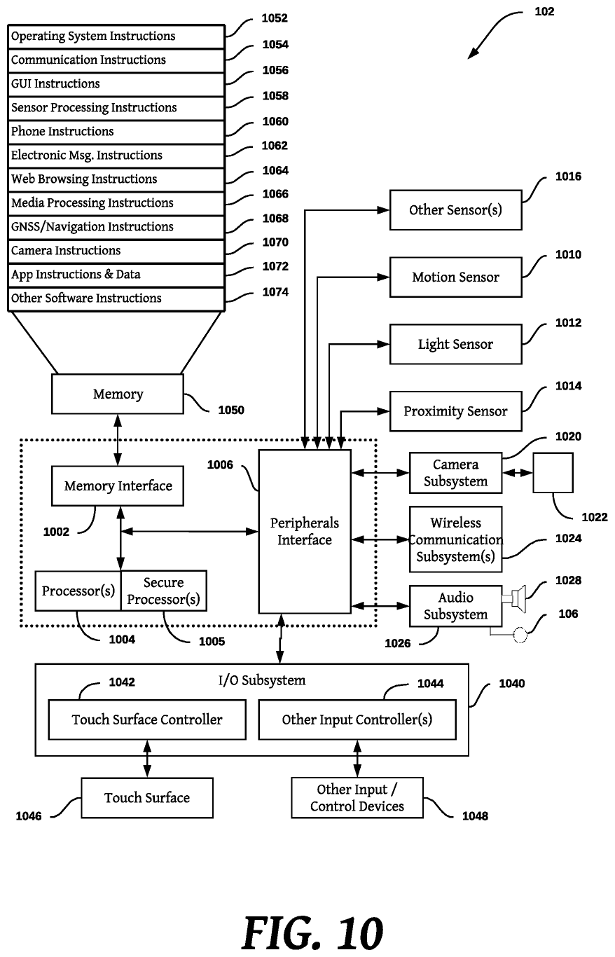

FIG. 10 shows a user device 1000 according to an embodiment of the present disclosure. The illustrative user device 1000 may include a memory interface 1002, one or more data processors, image processors, central processing units 1004, and/or secure processing units 1005, and a peripherals interface 1006. The memory interface 1002, the one or more processors 1004 and/or secure processors 1005, and/or the peripherals interface 1006 may be separate components or may be integrated into one or more integrated circuits. The various components in the user device 1000 may be coupled by one or more communication buses or signal lines.

Sensors, devices, and subsystems may be coupled to the peripherals interface 1006 to facilitate multiple functionalities. For example, a motion sensor 1010, a light sensor 1012, and a proximity sensor 1014 may be coupled to the peripherals interface 1006 to facilitate orientation, lighting, and proximity functions. Other sensors 1016 may also be connected to the peripherals interface 1006, such as a global navigation satellite system (GNSS) (e.g., GPS receiver), a temperature sensor, a biometric sensor, depth sensor, magnetometer, or another sensing device, to facilitate related functionalities.

A camera subsystem 1020 and an optical sensor 1022, e.g., a charged coupled device (CCD) or a complementary metal-oxide semiconductor (CMOS) optical sensor, may be utilized to facilitate camera functions, such as recording photographs and video clips. The camera subsystem 1020 and the optical sensor 1022 may be used to collect images of a user to be used during authentication of a user. e.g., by performing facial recognition analysis.

Communication functions may be facilitated through one or more wired and/or wireless communication subsystems 1024, which can include radio frequency receivers and transmitters and/or optical (e.g., infrared) receivers and transmitters. For example, the Bluetooth (e.g., Bluetooth low energy (BTLE)) and/or WiFi communications described herein may be handled by wireless communication subsystems 1024. The specific design and implementation of the communication subsystems 1024 may depend on the communication network(s) over which the user device 1000 is intended to operate. For example, the user device 1000 may include communication subsystems 1024 designed to operate over a GSM network, a GPRS network, an EDGE network, a WiFi or WiMax network, and a Bluetooth™ network. For example, the wireless communication subsystems 1024 may include hosting protocols such that the device 1000 can be configured as a base station for other wireless devices and/or to provide a WiFi service.

An audio subsystem 1026 may be coupled to a speaker 1028 and a microphone 1030 to facilitate voice-enabled functions, such as speaker recognition, voice replication, digital recording, and telephony functions. The audio subsystem 1026 may be configured to facilitate processing voice commands, voiceprinting, and voice authentication, for example.

The I/O subsystem 1040 may include a touch-surface controller 1042 and/or another input controller(s) 1044. The touch-surface controller 1042 may be coupled to a touch surface 1046. The touch surface 1046 and touch-surface controller 1042 may, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 1046.

The other input controller(s) 1044 may be coupled to other input/control devices 1048, such as one or more buttons, rocker switches, thumb-wheel, infrared port. USB port, and/or a pointer device such as a stylus. The one or more buttons (not shown) may include an up/down button for volume control of the speaker 1028 and/or the microphone 1030.

In some implementations, a pressing of the button for a first duration may disengage a lock of the touch surface 1046; and a pressing of the button for a second duration that is longer than the first duration may turn power to the user device 1000 on or off. Pressing the button for a third duration may activate a voice control, or voice command, a module that enables the user to speak commands into the microphone 1030 to cause the device to execute the spoken command. The user may customize a functionality of one or more of the buttons. The touch surface 1046 can, for example, also be used to implement virtual or soft buttons and/or a keyboard.

In some implementations, the user device 1000 may present recorded audio and/or video files, such as MP3, AAC, and MPEG files. In some implementations, the user device 1000 may include the functionality of an MP3 player, such as an iPod™. The user device 1000 may, therefore, include a 36-pin connector and/or 8-pin connector that is compatible with the iPod. Other input/output and control devices may also be used.

The memory interface 1002 may be coupled to memory 1050. The memory 1050 may include high-speed random access memory and/or non-volatile memory, such as one or more magnetic disk storage devices, one or more optical storage devices, and/or flash memory (e.g., NAND, NOR). The memory 1050 may store an operating system 1052, such as Darwin. RTXC, LINUX, UNIX, OS X, WINDOWS, or an embedded operating system such as VxWorks.

The operating system 1052 may include instructions for handling basic system services and for performing hardware dependent tasks. In some implementations, the operating system 1052 may be a kernel (e.g., UNIX kernel). In some implementations, the operating system 1052 may include instructions for performing voice authentication.

The memory 1050 may also store communication instructions 1054 to facilitate communicating with one or more additional devices, one or more computers and/or one or more servers. The memory 1050 may include graphical user interface (GUI) instructions 1056 to facilitate graphic user interface processing; sensor processing instructions 1058 to facilitate sensor-related processing and functions; phone instructions 1060 to facilitate phone-related processes and functions; electronic messaging instructions 1062 to facilitate electronic-messaging related processes and functions; web browsing instructions 1064 to facilitate web browsing-related processes and functions; media processing instructions 1066 to facilitate media processing-related processes and functions; GNSS/Navigation instructions 1068 to facilitate GNSS and navigation-related processes and instructions; and/or camera instructions 1070 to facilitate camera-related processes and functions.

The memory 1050 may store application instructions and data 1072 for generating a live room, configuring a live room, live streaming one or more content streams included in a live room, indexing one more audio files for in-audio search, and providing in audio search results as described herein. In various implementations, application data may include communication information, content metadata, content streams, live room settings, text to audio indices, performer profile information, community member profile information, and other information used or generated by other applications persisted on a user device.

The memory 1050 may also store other software instructions 1074, such as web video instructions to facilitate web video-related processes and functions; and/or web instructions to facilitate content sharing-related processes and functions. In some implementations, the media processing instructions 1066 may be divided into audio processing instructions and video processing instructions to facilitate audio processing-related processes and functions and video processing-related processes and functions, respectively.

Each of the above-identified instructions and applications may correspond to a set of instructions for performing one or more functions described herein. These instructions need not be implemented as separate software programs, procedures, or modules. The memory 1050 may include additional instructions or fewer instructions. Furthermore, various functions of the user device 1000 may be implemented in hardware and/or in software, including in one or more signal processing and/or application specific integrated circuits.

In some embodiments, processor 1004 may perform processing including executing instructions stored in memory 1050, and secure processor 1005 may perform some processing in a secure environment that may be inaccessible to other components of user device 1000. For example, secure processor 1005 may include cryptographic algorithms on board, hardware encryption, and physical tamper proofing. Secure processor 1005 may be manufactured in secure facilities. Secure processor 1005 may encrypt data/challenges from external devices. Secure processor 1005 may encrypt entire data packages that may be sent from user device 1000 to the network. Secure processor 1005 may separate a valid user/external device from a spoofed one, since a hacked or spoofed device may not have the private keys necessary to encrypt/decrypt, hash, or digitally sign data, as described herein.

The foregoing description is intended to convey a thorough understanding of the embodiments described by providing a number of specific exemplary embodiments and details involving livestreaming content, generating interactive content, indexing content for distribution, real time content moderation, and live user interactions. It should be appreciated, however, that the present disclosure is not limited to these specific embodiments and details, which are examples only. It is further understood that one possessing ordinary skill in the art, in light of known systems and methods, would appreciate the use of the invention for its intended purposes and benefits in any number of alternative embodiments, depending on specific design and other needs. A user device and server device are used as examples for the disclosure. The disclosure is not intended to be limited GUI display screens, content capture systems, data extraction processors, and client devices only. For example, many other electronic devices may utilize a system to generate and distribute live rooms to enable live interactions with audio content files.

Methods described herein may represent processing that occurs within a system (e.g., system 100 of FIG. 1). The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or another unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of nonvolatile memory, including, by ways of example, semiconductor memory devices, such as EPROM, EEPROM, flash memory device, or magnetic disks. The processor and the memory can be supplemented by, or incorporated in, special purpose logic circuitry.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

As used herein, the terms “and/or” and “at least one of” include any and all combinations of one or more of the associated listed items.

Certain details are set forth in the foregoing description and in FIGS. 1-11 to provide a thorough understanding of various embodiments of the present invention. Other details describing well-known structures and systems often associated with content generation, content streaming, live user interactions, content moderation, user devices, and server devices, etc., however, are not set forth below to avoid unnecessarily obscuring the description of the various embodiments of the present invention.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A method of livestreaming interactive content to a digital media platform comprising:
generating, by a livecast agent, a live room for broadcasting a livecast, the livecast comprising one or more content streams created inside the live room,
the live room identified by a performer hosting the livecast and livecast metadata including live room access information, the live room including one or more parameters for configuring the livecast;
publishing the live room and live room access information on the digital media platform;
using the live room access information, connecting one or more digital media platform users to the live room by establishing a network connection between an instance of the digital media platform on a user device of the one or more digital media platform users and a server device hosting the live room;
streaming the one or more content streams included in the livecast to the one or more digital media platform users connected to the live room and the performer;
receiving, inside the live room, one or more live user interactions with at least one content stream included in the livecast;
recording an audio content stream included in the livecast as a podcast episode;
uploading the podcast episode to the digital media platform; and
distributing the podcast episode on the digital media platform, wherein dialogue included in the podcast episode is text searchable on the digital media platform.

2. The method of claim 1, wherein the livecast metadata includes livecast title, one or more greetings to livecast listeners, searchable tags, a number of digital media platform users connected to the livecast, and a cover photo.

3. The method of claim 1, wherein the one or more live user interactions comprise a text message, a phone call, a virtual gift, a content rating, and a podcast channel subscription.

4. The method of claim 3, wherein the one or more content streams include an audio content stream from the performer and an audio content stream from at least one of the one or more digital media platform users connected to the live room.

5. The method of claim 4, wherein the one or more content streams include a content feed displaying text comments, user call-in history, virtual gift transactions, and profile names of the one or more digital media platform users connected to the live room.

6. The method of claim 1, comprising:
generating a notification including livecast metadata and live room access information including a link to access the livecast on the digital media platform; and
distributing the notification to a social media platform.

7. The method of claim 6, wherein the link to access the livecast includes a playback position that directs one or more users of a social media platform accessing the livecast using the link to the playback position within a playback timeline of the livecast to allow the one or more users of a social media platform to begin playing the livecast from the playback position instead of the beginning of the livecast.

8. The method of claim 1, wherein the live room is generated automatically according to a schedule specifying one or more dates and times for streaming the livecast.

9. The method of claim 8, comprising:
in advance of the generating the live room, creating a notification including an upcoming date and time for streaming the livecast, the livecast metadata, and access information including a link to access the livecast on the digital media platform; and
distributing the notification to a social media platform.

10. The method of claim 8, wherein the link is a static link that remains constant for all livecasts hosted by the performer.

11. The method of claim 1, wherein the one or more parameters comprise privacy settings, explicit content identification, notification settings, and recording settings.

12. The method of claim 11, wherein the performer may restrict digital media platform users that can connect to the livecast using the privacy settings.

13. A method of livestreaming interactive content to a digital media platform comprising:
generating, by a livecast agent, a live room for broadcasting a livecast, the livecast comprising one or more content streams created inside the live room,
the live room identified by a performer hosting the livecast and livecast metadata including live room access information, the live room including one or more parameters for configuring the livecast;
publishing the live room and live room access information on the digital media platform;
using the live room access information, connecting one or more digital media platform users to the live room by establishing a network connection between an instance of the digital media platform on a user device of the one or more digital media platform users and a server device hosting the live room;
streaming the one or more content streams included in the livecast to the one or more digital media platform users connected to the live room and the performer;
receiving, inside the live room, one or more live user interactions with at least one content stream included in the livecast;
recording an audio content stream included in the livecast as a podcast episode;
receiving, by an audio analyzer, the podcast episode, the audio analyzer generating a text to audio index for the podcast by:
slicing the podcast episode into audio clips including segments of dialogue;
for each audio clip, obtaining text and timeline information for every word included in the dialogue, the timeline information placing each word in a position on a playback timeline that corresponds with a playback time of the podcast episode when the word was spoken; and
calibrating the timeline information to correct in-accurate timeline positions of one or more words included in the dialogue; and
distributing the podcast episode to the digital media platform, wherein dialogue included in the podcast episode is text searchable on the digital media platform using the text to audio index.

14. The method of claim 13, wherein the live room is generated automatically according to a schedule specifying one or more dates and times for streaming the livecast.

15. The method of claim 13, wherein the calibrating timeline information comprises applying a scaling factor to expand the playback timeline to allow more words to be placed in a unique timeline position on the playback timeline.

16. The method of claim 13, wherein the calibrating timeline information comprises applying a scaling factor to compress the playback timeline to reduce a number of unique timeline positions available for placing words on the playback timeline

17. A method of livestreaming interactive content to a digital media platform comprising:
generating, by a livecast agent, a live room for broadcasting a livecast, the livecast comprising one or more content streams created inside the live room,
the live room identified by a performer hosting the livecast and livecast metadata including live room access information, the live room including one or more parameters for configuring the livecast;
publishing the live room and live room access information on the digital media platform;
using the live room access information, connecting one or more digital media platform users to the live room by establishing a network connection between an instance of the digital media platform on a user device of the one or more digital media platform users and a server device hosting the live room;
streaming the one or more content streams included in the livecast to the one or more digital media platform users connected to the live room and the performer;
receiving, inside the live room, a call-in live user interaction including an audio interaction between a digital media platform user connected to the live room and the performer;
recording one or more audio content streams included in the livecast as a podcast episode, the recorded one or more audio content streams comprising the audio interaction included in the call-in live user interaction;
uploading the podcast episode to the digital media platform; and
distributing the podcast episode on the digital media platform, wherein dialogue included in the call-in live user interaction is text searchable on the digital media platform.

18. The method of claim 17, wherein the one or more content streams include an audio content stream from the performer, an audio content stream from at least one of the one or more digital media platform users connected to the live room, and a content feed displaying text comments, user call-in history, virtual gift transactions, and profile names of the one or more digital media platform users connected to the live room.

19. The method of claim 17, comprising:
receiving a text message live interaction from the digital media platform user, the text message live interaction including a text message published in the content feed.

20. The method of claim 17, comprising:
receiving a virtual gift live interaction from the digital media platform user, the virtual gift including an image of the virtual gift given by the digital media platform user to the performer, the virtual gift published in the content feed and redeemable, on the digital media platform, for a cash value by the performer.
